(19) United States
(12) Patent Application Publication
(10) Pub. No.: US 2008/0221950 A1
(43) Pub. Date: Sep. 11, 2008

(54) STORAGE MEDIUM HAVING REQUIREMENT CONFIRMATION SUPPORT PROGRAM STORED THEREIN, REQUIREMENT CONFIRMATION SUPPORT METHOD, AND REQUIREMENT CONFIRMATION SUPPORT APPARATUS

(75) Inventors: Sadayo HIRATA, Kawasaki (JP); Yoshiaki Shuto, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, KANAGAWA (JP)

(21) Appl. No.: 12/041,153

(22) Filed: Mar. 3, 2008

(30) Foreign Application Priority Data
Mar. 5, 2007 (JP) 2007-54712

(51) Int. Cl. G06Q 10/00

(52) U.S. Cl. 705/7

(57) ABSTRACT

A requirement confirmation support program a requirement confirmation support method, and a requirement confirmation support apparatus for supporting necessary and sufficient consensus formation between proper representatives.

### CROSS-REFERENCE TO RELATED APPLICATIONS

This application claims the benefit of Japanese Patent Application No. 2007-54712, filed Mar. 5, 2007, in the Japanese Intellectual Property Office, the disclosure of which is incorporated herein by reference.

### BACKGROUND

1. Field of the Invention

The present invention relates to a storage and a requirement confirmation support.

2. Description of the Related Art

Problems, such as delay in construction schedule increase in cost, and difficulty in ensuring required quality, which occur in developing the information system are frequently attributed to procrastination of ambiguities in a plan prior to system formulation or in a requirement defining stage. In order to correct the procrastination of ambiguities, it is necessary desired hat all requirements be presented in the requirement defining process to obtain agreement on the requirements among various stakeholders such as a customer, a designer, and an operator.

Conventionally, the agreement on the requirement defining process among the stakeholders has been made by a method in which a requirement defining document is confirmed between a representative of a department in charge of contract management or information system management of an ordering company and a representative of an order received company. Accordingly, a degree of completion of the requirement definition is evaluated and managed, for example, based on the number of requirements, the number of documents, and the number of reviews, and the process is considered to be completed after an allowance period.

In such conventional methods, however, the requirement definition can be confirmed only within a range of which each representative takes control. The representative is selected according to a position and experience, a specialized field, a degree of contribution to the information system, and the like. However, it is difficult to objectively judge adequateness of personnel selection or the number of persons.

In the conventional requirement defining process, it is very difficult to objectively evaluate the degree of completion of the requirement definition. In other words, it is difficult to determine whether the personnel selection is adequate, whether all the requirements are presented, and how many requirements are agreed in all the presented requirements.

Conventionally, as to the personnel selection, when the representative of the designated department confirms and agrees on the requirement definition, knowledge, interest, and thinking tend to be biased compared with a distribution of all the actual stakeholders. In addition to an original character possessed by the representative (for example, a character attempting to take in a new thing or a character attempting to avoid the new thing), presentation of the requirements or a tendency whether the representative can agree on the presented requirements depends on a representative's position. For example, when the representative is in charge of ensuring a budget, the representative tends to present the conservative requirements. On the other hand, the representative familiar with new technology tends to present innovative requirements.

It is also difficult to judge how many stakeholders agree the requirements. In the requirement defining process, a change is generated as time advances and amendment is made in the consensus formation. In such cases, how many stakeholders agree the current requirements becomes unclear. Sometimes the thinking of the representative is changed as time advances. Particularly, when the representative who has insufficient knowledge and experience at an initial stage confirms the requirements, the representative deepens understanding during the confirmation and tends to change the already settled requirement.

Thus, in the conventional method, the ambiguities procrastinate because the degree of completion of the requirement definition cannot objectively be evaluated. Frequently, a system constructed under the ambiguous agreement is not suitable to the actual operation, and the system is reconstructed.

### SUMMARY

In view of the foregoing, example embodiments of the present invention provide a requirement confirmation support program, a requirement confirmation support method, and a requirement confirmation support apparatus for supporting necessary and sufficient consensus formation between proper representatives.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a block diagram of an embodiment;

FIG. 2 is a graph illustrating illustrates stakeholder distribution in a requirement defining process model according to an embodiment;

FIG. 3 is an example configuration diagram illustrating a requirement confirmation support system which supports a requirement definition confirming work in a requirement defining process of an information system according to an embodiment,

FIG. 4 is a block diagram illustrating a hardware configuration example of a requirement confirmation support apparatus according to an embodiment of the invention;

FIG. 5 is a block diagram that illustrates a software configuration of a requirement confirmation support apparatus according to an embodiment;

FIG. 6 is a block diagram that illustrates a processing flow of a stakeholder determination unit according to an embodiment of the invention;

FIG. 7 illustrates an example of a stakeholder table;

FIG. 8 illustrates an example of a determination keyword table;

FIG. 9 illustrates an example of a cluster table;

FIG. 10 is a flowchart illustrating a procedure of cluster classification processing according to an embodiment;

FIG. 11 illustrates a processing flow of a cluster distribution generating and display unit according to an embodiment of the invention;

FIG. 12 illustrates an example of a project-by-project cluster distribution number table;

FIG. 13 illustrates an example of a project-by-project cluster distribution ratio table;

FIG. 14 illustrates an example of a cluster distribution display screen;

FIG. 15 illustrates a processing flow of a requirement defining model selecting unit according to an embodiment;

FIG. 16 illustrates an example of a business sector and requirement defining model corresponding table;

FIG. 17 illustrates an example of an object and requirement defining model corresponding table;

FIG. 18 illustrates an example of a scale and requirement defining model corresponding table;

FIG. 19 illustrates an example of a factor-by-factor requirement defining model corresponding table;

FIG. 20 illustrates an example of a project-by-project requirement defining model table;

FIG. 21 illustrates an example of a model-by-model cluster distribution ratio table;

FIG. 22 illustrates an example of a project-by-project requirement defining model distribution number table;

FIG. 23 illustrates a processing flow of a requirement defining model generating and display unit according to an embodiment of the invention;

FIG. 24 illustrates an example of a requirement defining model distribution display screen;

FIG. 25 illustrates a display screen of comparison between a cluster distribution and a requirement defining model distribution;

FIG. 26 illustrates a processing flow of a satisfaction level measuring unit according to an embodiment of the invention;

FIG. 27 illustrates examples of a review menu screen and a satisfaction manipulation screen;

FIG. 28 illustrates an example of a stakeholder-by-stakeholder review information table;

FIG. 29 illustrates an example of a stakeholder-by-stakeholder satisfaction counter table;

FIG. 30 illustrates an example of a stakeholder-by-stakeholder satisfaction level table;

FIG. 31 illustrates a processing flow of a cluster-by-cluster satisfaction level generating and display unit according to an embodiment;

FIG. 32 illustrates an example of a specified time satisfaction status display screen;

FIG. 33 illustrates an example of a specified cluster satisfaction level transition display screen;

FIG. 34 illustrates an example of a requirement defining document item-by-item entire cluster satisfaction status display screen;

FIG. 35 illustrates an example of a requirement defining document item-by-item specified cluster satisfaction status display screen;

FIG. 36 illustrates a processing flow of a requirement definition delay measure unit according to an embodiment;

FIG. 37 illustrates an example of an enhanced cluster display screen;

FIG. 38 illustrates an example of an enhanced cluster advice display screen;

FIG. 39 illustrates an example of a satisfaction baseline display screen;

FIG. 40 illustrates an example of a contingency plan table;

FIG. 41 illustrates an example of a delay amount advice display screen;

FIG. 42 illustrates a processing flow of a requirement definition desirable practice management unit according to an embodiment of the invention;

FIG. 43 illustrates an example of a project result table; and

FIG. 44 illustrates an example of a desirable practice sample display screen.

### DETAILED DESCRIPTION OF THE PREFERRED EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

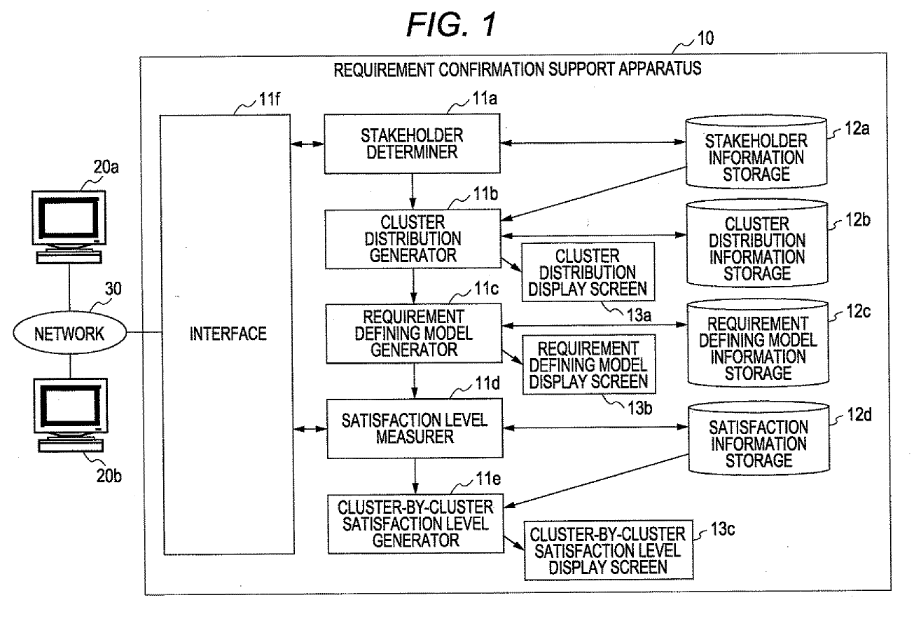

An example embodiment of the invention will be described below with reference to the drawings. FIG. 1 is a block diagram of an embodiment.

A requirement confirmation support apparatus 10 according to an embodiment includes a processor and a storage to support a requirement defining process in an information system development. The processor includes a stakeholder determiner 11a, a cluster distribution generator 11b, a requirement defining model generator 11c, a satisfaction level measurer 11d, a cluster-by-cluster satisfaction level generator 11e, and an interface 11f. The storage includes a stakeholder information storage 12a, a cluster distribution information storage 12b, a requirement defining model information storage 12c, and a satisfaction information storage 12d. In each processor of the requirement confirmation support apparatus 10, a computer executes a requirement confirmation support program to perform a processing function of each processing means. Each processor is connected to a stakeholder A terminal 20a and a stakeholder B terminal 20b through a network 30.

The stakeholder determiner 11a extracts all the stakeholders (all the involved persons such as an ordering person, a development person, an operator, and a user) involved in an information system of a target project, and classifies the extracted stakeholder into clusters. Although described in detail later, in the requirement defining process of the information system development can model, the stakeholder can be modeled using a stakeholder type classified according to the character of thinking about the information system. A group of stakeholders having the same stakeholder type can be called a cluster. The stakeholder determination 11a determines the stakeholder type for the extracted stakeholder by analyzing related information including a personal history, a skill, a research performance, and documents such as a published paper. For example, keywords expressing the characters of the type are previously set in each stakeholder type, and the pieces of related information are collated with the setting keywords. Then, the stakeholder is classified into the stakeholder type having the most number of matched keywords. The cluster classification for the determined stakeholder type and stakeholder identification information for identifying the individual stakeholder are related to each other to generate stakeholder information, and the stakeholder information is stored in the stakeholder information storage 12a.

The cluster distribution generator 11b generates stakeholder cluster distribution information by computing the number of persons and a number ratio in each cluster based on the stakeholder information stored in the stakeholder information storage 12a. The number of stakeholders classified into each cluster and a number ratio (ration of the number of stakeholders belonging to a certain cluster to the whole number of stakeholders) are set in the cluster distribution information while related to the cluster. The cluster distribution generator 11b displays a cluster distribution display screen 13a on a display device based on the cluster distribution information in response to a request from the stakeholder or a manager (not shown) through the terminals 20a and 20b.

The requirement defining model generator 11c generates a cluster distribution model based on a requirement defining model which is modeled according to the information system. In the requirement defining model, a stakeholder distribution ratio can be defined in each cluster. On the basis of the definition, the requirement defining model generator 11c computes the number of stakeholders in each cluster suitable to the information system to form the cluster distribution model. The cluster distribution model is stored in the requirement defining model information storage 12c. Similarly to the cluster distribution display screen 13a, the requirement defining model generator 11c displays the display screen if needed based on the cluster distribution model computed as a requirement defining model display screen 13b.

The satisfaction level measurer 11d generates satisfaction information based on information informing that a satisfaction button is manipulated. The information is sent from the stakeholder A terminal 20a or the stakeholder B terminal 20b through an interface 11f. The requirement definition is opened to all the stakeholders. Each stakeholder confirms the opened requirement definition using the terminal, and manipulates the satisfaction button when the requirement definition is satisfied. At this point, the terminal notifies the requirement confirmation support apparatus 10 through the network 30 of at least stakeholder identification information and a manipulated requirement defining item along with a search status such as manipulation date and time of the satisfaction button. When receiving the notification, the satisfaction level measurer 11d generates the satisfaction information while relating the satisfaction information to the stakeholder identification information, and stores the satisfaction information in the satisfaction information storage 12d.

The cluster-by-cluster satisfaction level generator 11e aggregates the stakeholder-by-stakeholder satisfaction information stored in the satisfaction information storage 12d in each cluster based on the stakeholder information stored in the stakeholder information storage 12a, and generates cluster-by-cluster satisfaction level information. Then, the cluster-by-cluster satisfaction level generator 11e displays a cluster-by-cluster satisfaction level display screen 13c based on the cluster-by-cluster satisfaction level information.

The interface 11f controls data exchange between the stakeholder terminal and each of the processor of the requirement confirmation support apparatus 10 through the network 30.

The stakeholder information storage 12a stores the stakeholder information in which the stakeholder identification information and the information on the cluster into which the stakeholder is classified are related to each other. The cluster distribution information storage 12b stores the cluster distribution information in which the cluster, the number of stakeholders belonging to the cluster, and the number ratio are related to one another. The requirement defining model information storage 12c stores the cluster distribution model which is based on the requirement defining model. The satisfaction information storage means 12d stores the satisfaction information in which the requirement defining item satisfying the stakeholder and the satisfaction button manipulation status are related to the stakeholder identification information.

The stakeholder A terminal 20a and the stakeholder B terminal 20b are connected to the requirement confirmation support apparatus 10 through the network 30. Through the stakeholder's manipulation of the satisfaction button, the stakeholder A terminal 20a and the stakeholder B terminal 20b notify the requirement confirmation support apparatus 10 that the stakeholder confirms the opened requirement definition to satisfy the requirement definition. The stakeholder A terminal 20a and the stakeholder B terminal 20b obtain various pieces of information from the requirement confirmation support apparatus 10 to display the various pieces of information on the display screen in response to a request from the stakeholder.

An example operation of the requirement confirmation support apparatus 10 having the above-described configuration will be described. The stakeholder determiner 11a extracts the stakeholder concerning a target information system, analyzes the stakeholder type, and classifies the stakeholder into the cluster according to the stakeholder type. The information on the set cluster is stored in the stakeholder information storage 12a while related to the stakeholder identification information. On the basis of the cluster set in each stakeholder, the cluster distribution generator 11b computes the number of stakeholders belonging to the cluster and the number ratio and generates the cluster distribution information in each cluster stored in the stakeholder information storage 12a. The cluster distribution generator 11b displays the cluster distribution display screen 13a if needed. The requirement defining model generator 11c generates the cluster distribution model based on the requirement defining model, and displays the requirement defining model display screen 13b if needed. A determination whether the configuration of the stakeholder is proper can be made by comparing the cluster distribution display screen 13a based on the actual cluster distribution and the requirement defining model display screen 13b based on the model.

The satisfaction level measurer 11d measures a satisfaction level of the requirement defining item of each stakeholder, and stores the satisfaction level information in the satisfaction information storage 12d. The cluster-by-cluster satisfaction level generator 11e aggregates the satisfaction-by-satisfaction satisfaction information in each cluster to display the satisfaction-by-satisfaction satisfaction information as the cluster-by-cluster satisfaction level display screen 13c. This makes it possible to objectively understand what type the satisfaction level is lowered, thereby to take a measure.

Thus, according to an embodiment, the status of the actual requirement defining process can objectively be evaluated by comparison with the requirement defining model. For example, whether a proper representative is selected can be confirmed by collating the cluster distribution display screen 13a expressing the actual cluster distribution with the requirement defining model display screen 13b based on the cluster distribution model. It is possible to objectively understand whether the necessary and sufficient consensus formation is obtained, by referring to the cluster-by-cluster satisfaction level display screen 13c. In the case of the insufficient consensus, such a tendency in what type the satisfaction level is lowered can be known. Thus, the procrastination of ambiguities can be prevented through the objective evaluation on the degree of completion of the requirement definition.

An embodiment of the invention will be described below with reference to the drawings.

First, A requirement defining process model can be used in the embodiment.

Conventionally, there can be modeled a life cycle in which different types of persons of an innovator (innovative), an early adopter (visionary party), an early majority (rationalism), a late majority (solid party), and a laggard (high-technology hater) provide requirements to accept products in the case where electronics products such as a digital camera based on IT (Information Technology) become widespread. On the other hand, the information system has the difficulty. That is, the information system is not frequently replaced unlike the electronic products and the requirements satisfying all the users are defined before development. Character or distribution of the person providing the requirement can be modeled like electronic products.

For example, a process until the stakeholder accepts the requirement definition since the requirement definition is presented can be can be defined as a request penetration life cycle in the requirement defining process of the information system. In the request penetration life cycle, the stakeholder who provides the request to the information system can be defined while classified into a “foreseeing person (innovator),” for example a person initially presenting an innovative requirement, an “embodying person (adopter),” for example a person presenting a vision-oriented requirement, a “practical-minded person (majority),” for example, a person presenting a realistic requirement to a resource or technology, and a “breakdown person,” for example a person presenting a conservative or skeptical requirement. The four classifications are examples of the character of the stakeholder who presents the request and process through which the requirement is gradually accepted. Processes can be performed based on the model as a technique of procrastinating the ambiguities of the requirement definition in the requirement defining process. That is, (1) in order to draw the requirement of the whole usage scene of the information system, the requirement is extracted in each type of stakeholder to open all the stakeholders. (2) The stakeholders mutually understand an essence of the requirement. (3) The stakeholder uses (1) to understand the requirements of other stakeholders, thereby knowing a cause-and-effect relationship among the requirements. (4) The stakeholder understands other requirements to re-consider a need of each requirement, and the stakeholder adds and changes the requirement. (5) The stakeholder makes a choice of the requirement after the addition and change based on the satisfaction and consensus among the representatives of the different types of stakeholders.

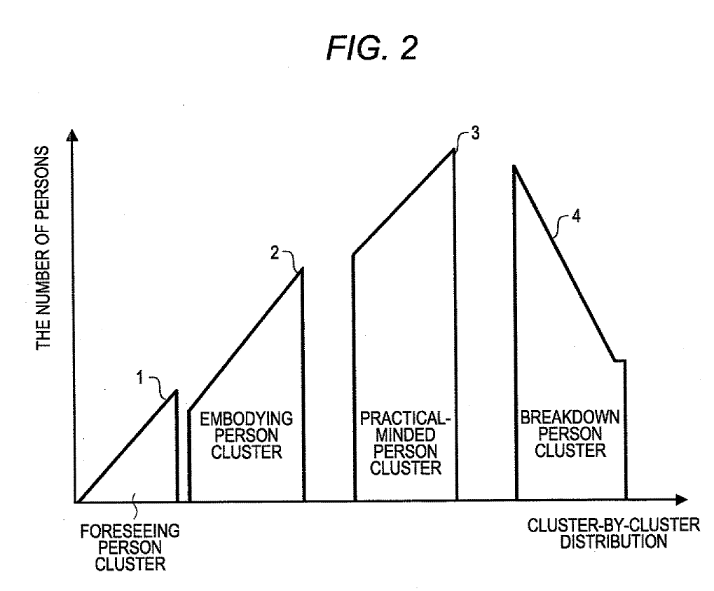

According to an example embodiment, the confirming work in the requirement defining process is supported based on the processes. FIG. 2 illustrates a stakeholder distribution in the requirement defining process model of the embodiment.

In the embodiment, all the stakeholders are classified into a foreseeing person cluster 1, an embodying person cluster 2, a practical-minded person cluster 3, and a breakdown person cluster 4, and a distribution status of the clusters is visualized. The presented requirement definition is opened to all the stakeholders, and the satisfaction levels obtained from the stakeholders are aggregated to visualize the status of the satisfaction level. The stakeholders and the manager who manages the process can objectively understand a progress of the requirement defining process and the degree of completion of the requirement definition based on the pieces of visualized information.

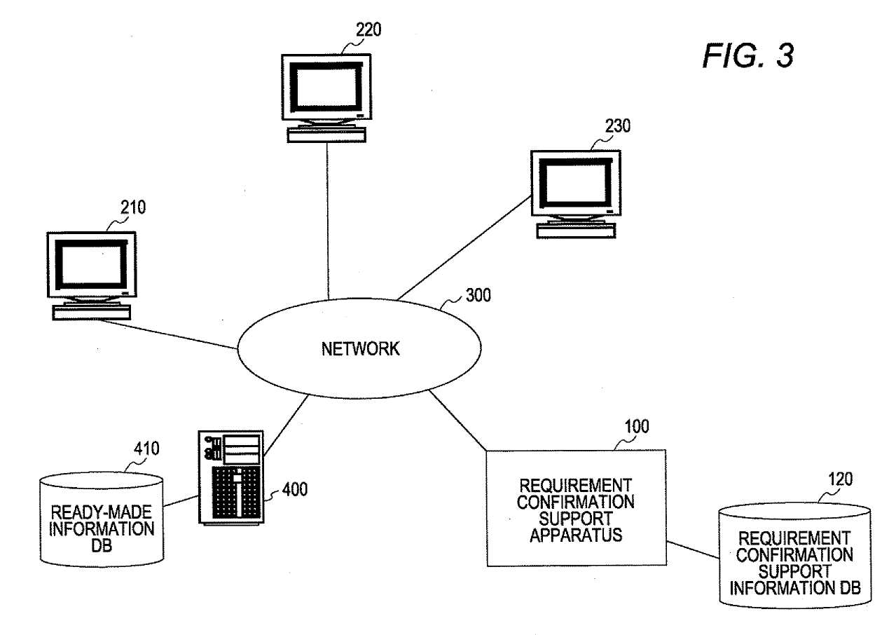

An example configuration of the requirement confirmation support system of the embodiment will be described below. FIG. 3 is an example configuration diagram illustrating the requirement confirmation support system which supports a requirement definition confirming work in the requirement defining process of the information system of the embodiment.

In the requirement confirmation support system of the embodiment, a requirement confirmation support apparatus 100 for supporting the requirement confirmation is connected to terminal devices of the stakeholders who present and confirm the requirement and a server 400 through a network 300. The terminal devices include a stakeholder A terminal 240, a stakeholder B terminal 220, and a stakeholder C terminal 230. The server 400 retains the pieces of information on the history and skill of the stakeholder and research performance.

The requirement confirmation support apparatus 100 is connected to a requirement confirmation support information database (hereinafter referred to as DB) 120 to collect the information from the server 400 if needed, and the requirement confirmation support apparatus 100 is connected to the stakeholder A terminal 210, stakeholder B terminal 220, and stakeholder C terminal 230 to provide the information or request the requirement confirmation,

The stakeholder A terminal 210, the stakeholder B terminal 220, and the stakeholder C terminal 230 collect the progress of the requirement defining process from the requirement confirmation support apparatus 100 and display the progress of the requirement defining process in response to the user's manipulation. The stakeholder A terminal 210, the stakeholder B terminal 220, and the stakeholder C terminal 230 display a user's manipulation screen of requirement definition approval. When the user performs the approval manipulation, the user's approval is notified to the requirement confirmation support apparatus 100. The server 400 is connected to a ready-made information DB 410 to provide various kinds of information in response to a request from the requirement confirmation support apparatus 100. The ready-made information DB 410 stores the related information on the stakeholder and ready-made information such as document of published paper.

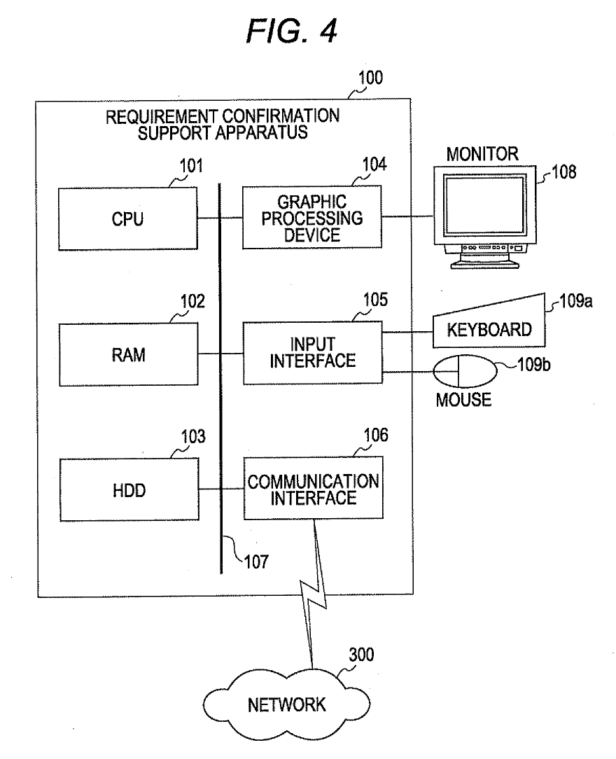

An example hardware configuration of the requirement confirmation support apparatus 100 will be described. FIG. 4 is a block diagram illustrating the hardware configuration example of the requirement confirmation support apparatus of the embodiment.

A CPU (Central Processing Unit) 101 controls the whole of the requirement confirmation support apparatus 100. A RAM (Random Access Memory) 102, an HDD (Hard Disk Drive) 103, a graphic processing device 104, an input interface 105, and a communication interface 106 are connected to the CPU 101 through a bus 107.

A part of a program of OS (Operating System) or an application program, which is executed by the CPU 101, is tentatively stored in the RAM 102. Various kinds of data necessary for processing performed by the CPU 101 are also stored in the RAM 102. OS and the application program are stored in the HDD 103. A monitor 108 is connected to the graphic processing device 104, and an image is displayed on a screen of the monitor 108 in response to a command from the CPU 101. A keyboard 109a and a mouse 109b are connected to the input interface 105, and the input interface 105 transmits a signal, sent from the keyboard 109a or mouse 109b, to the CPU 101 through the bus 107. The communication interface 106 is connected to a network 300, and the communication interface 106 transmits and receives data to and from the terminal devices 210, 220, and 230 or server 400 through the network 300.

The processing function of the embodiment can be realized by the hardware configuration. Although FIG. 4 illustrates only the hardware configuration of the requirement confirmation support apparatus, the same holds true for the hardware configurations of the terminal devices and other servers.

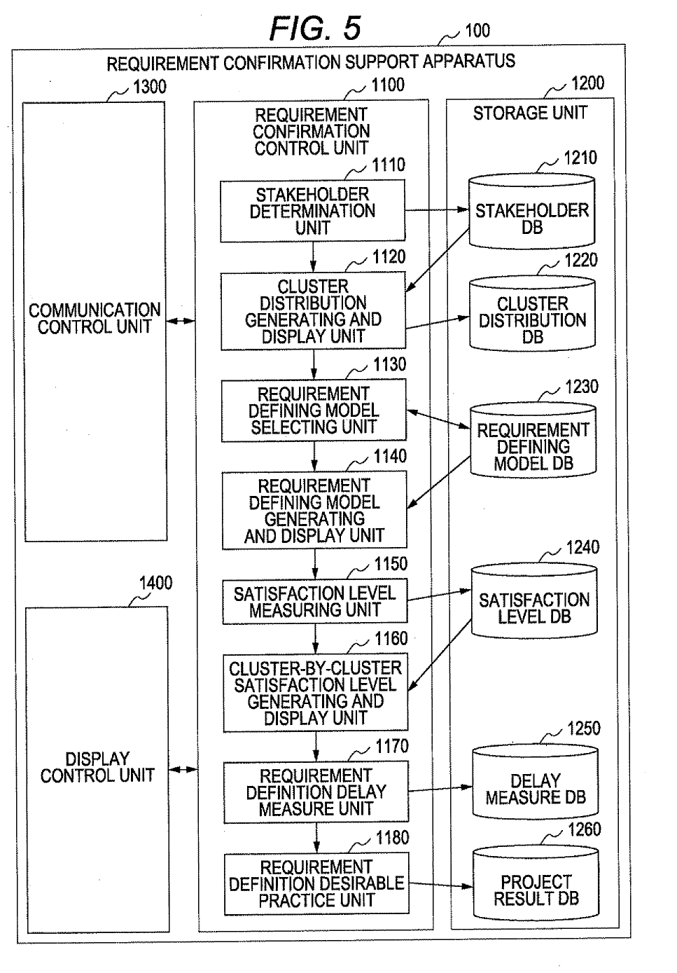

A software configuration of the requirement confirmation support apparatus of the embodiment will be described below. FIG. 5 illustrates the software configuration of the requirement confirmation support apparatus of the embodiment.

The requirement confirmation support apparatus 100 includes a requirement confirmation control unit 1100 which controls requirement confirmation support processing, a storage unit 1200 which is formed by various information databases, a communication control unit 1300 which controls communication, and a display control unit 1400 which controls display.

The requirement confirmation control unit 1100 includes a stakeholder determination unit 1110, a cluster distribution generating and display unit 1120, a requirement defining model selecting unit 1130, a requirement defining model generating and display unit 1140, a satisfaction level measuring unit 1150, a cluster-by-cluster satisfaction level generating and display unit 1160, a requirement definition delay measure unit 1170, and a requirement definition desirable practice management unit 1180.

The stakeholder determination unit 1110 can serve as the stakeholder determiner 11a to classify the stakeholder into the cluster according to the stakeholder type. The cluster distribution generating and display unit 1120 can serve as the cluster distribution generator 11b to compute and display the stakeholder cluster distribution. The requirement defining model selecting unit 1130 selects the requirement defining model suitable to the target information system. In the requirement defining model, an optimum component ratio of the clusters depends on, for example, a business sector, an object, and a scale of the target information system. Therefore, plural requirement defining models having different component ratios of the clusters are previously prepared and the optimum requirement defining model is selected according to the target information system. The requirement defining model generating and display unit 1140 can serve as the requirement defining model generator 11c to generate and display the cluster distribution model based on the requirement defining model selected by the requirement defining model selecting unit 1130. The satisfaction level measuring unit 1150 can act as the satisfaction level measurer 11d to measure the satisfaction level of the stakeholder for the requirement defining item. The cluster-by-cluster satisfaction level generating and display unit 1160 can serve as the cluster-by-cluster satisfaction level generator 11e, and aggregates the stakeholder-by-stakeholder satisfaction level measured by the satisfaction level measuring unit 1150 in each cluster and displays the result. The requirement definition delay measure unit 1170 compares the computed satisfaction level and a reference value to understand the progress of the requirement definition consensus based on the aggregation of the cluster-by-cluster satisfaction level generating and display unit 1160. The requirement definition delay measure unit 1170 also makes comparison with a predicted time to the consensus to understand the status whether delay is generated. A measure is previously prepared, and what effective measure is selected based on the understood status, and the selected measure is presented to the user. In ending the project, the requirement definition desirable practice management unit 1180 leaves the information generated in the above-described processing procedure along with the keywords such as success and failure. In starting a new project, when the new project are similar to the previous project in the features of the information system such as the business sector, object, user scale, and operation conditions, the user is notified as desirable practice or desirable/undesirable practice.

The storage unit 1200 includes a stakeholder DB 121 in which the stakeholder information is stored, a cluster distribution DB 1220 in which the cluster distribution information is stored, a requirement defining model DB 1230 in which the cluster distribution model is stored, a satisfaction level DB 1240 in which the satisfaction level information is stored, a delay measure DB 1250 in which information on a delay measure is stored, and a project result DB 1260 in which information on the ended project is stored along with the keyword. Each DB will be described in detail later.

In the requirement confirmation support apparatus 100, the stakeholder determination unit 1110 classifies the stakeholders involved in the information system into the clusters, the cluster distribution generating and display unit 1120 performs aggregation in each classification to compute and display the stakeholder distribution status in each cluster. The requirement defining model generating and display unit 1140 generates and displays the cluster distribution model based on the requirement defining model which is selected according to the target information system by the requirement defining model selecting unit 1130. The satisfaction level measuring unit 1150 measures the satisfaction level of the requirement definition in each stakeholder, and the cluster-by-cluster satisfaction level generating and display unit 1160 aggregates the satisfaction levels of the requirement definition to compute and display the cluster-by-cluster satisfaction level.

The requirement definition delay measure unit 1170 analyzes the current delay status of the requirement defining process and the delay point based on the information generated by the processing unit. When the project is ended, the requirement definition desirable practice management unit 1180 manages the generated information along with the keywords such as the success and failure to use the information in subsequent projects.

The requirement confirmation support apparatus 100 supports the requirement confirmation in the above-described procedure.

Each processing unit will be described in detail along an example processing flow.

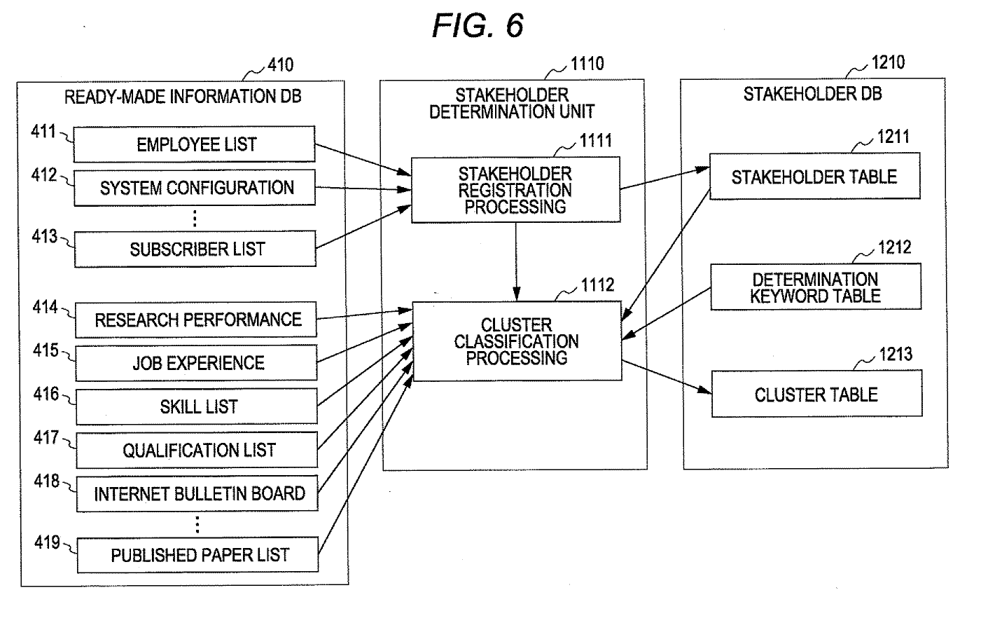

FIG. 6 illustrates a processing flow of the stakeholder determination unit of the embodiment.

The stakeholder determination unit 1110 sequentially performs stakeholder registration processing 1111 for extracting and registering the stakeholder and cluster classification processing 1112 for classifying the stakeholder into the cluster.

An employee list 411, which is stored in the ready-made information DB 410, is a list of employees of an ordering company involved in the target project, an information system development company, and an operation company which is in charge of the operation and management. A system configuration 412 is information indicating a system of each company to recognize a division. A subscriber list 413 is a list of subscribers who participate in any association such as an academic society. The stakeholder can be extracted from the pieces of information. A research performance 414, a job experience 415, a skill list 416, a qualification list 417, an Internet bulletin board 418, and a published paper list 419 are information for detecting the stakeholder's character of the thinking to the information system, which can be collected through the network 300. The pieces of information are not collected through the network 300, but the user may manually set the pieces of information.

In the stakeholder registration processing 1111, the employee list 411, system configuration 412, and subscriber list 413 are referred to, thereby extracting persons such as the ordering person, designer, operator, and user of the information system as the stakeholder who are involved in the target project. A unique stakeholder number is allocated to the extracted stakeholder, and the information on the stakeholder is set in the stakeholder table 1211 while a stakeholder number and a system number of the target information system are used as a key. At this point, the total number of stakeholders is also computed in each project.

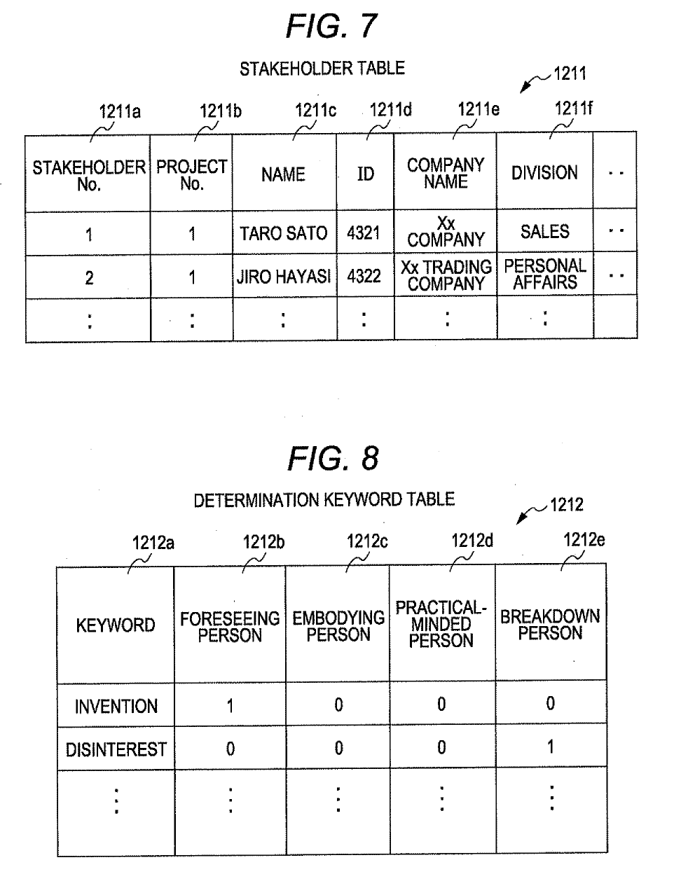

FIG. 7 illustrates an example of a stakeholder table.

The information on the stakeholder is registered in a stakeholder table 1211 while related to a stakeholder number 1211a and a project number 1211b. The stakeholder number 1211a is stakeholder identification information for specifying the individual stakeholder, and the project number 1211b is project identification information for specifying the individual project. In FIG. 7, a stakeholder name 1211c, an ID 1211d, a company name 1211e, a division 1211f and the like are extracted from the ready-made information DB 410 and displayed.

FIG. 8 illustrates an example of a determination keyword table.

Keywords 1212a indicating the character of the stakeholder type is set in a determination keyword table 1212. Whether the keyword is used is also set in the determination keyword table 1212 in each stakeholder type (foreseeing person 1212b, embodying person 1212c, practical-minded person 1212d, and breakdown person 1212e). “1” is set to the stakeholder type in which the keyword is frequently used. For example, the “foreseeing person” frequently uses the keyword of “invention”.

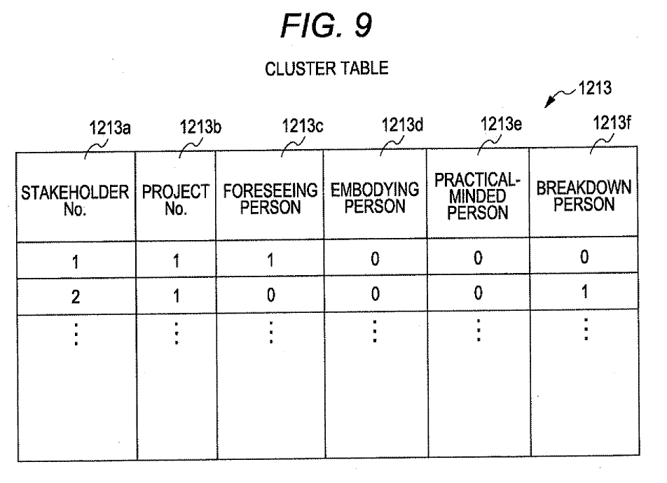

FIG. 9 illustrates an example of a cluster table.

A stakeholder number 1213a is registered in a cluster table 1213. One of a foreseeing person 1213c, an embodying person 1213d, a practical-minded person 1213e, and a breakdown person 1213f is also registered in the cluster table 1213 while related to a project number 1213b. “1” is set to the corresponding stakeholder type. For example, the stakeholder specified by the stakeholder number of “1” and project number of “1” is classified into the “foreseeing person”.

Then, in the cluster classification processing 1112, the ready-made information on the stakeholder set in the stakeholder table 1211 is obtained through the stakeholder registration processing 1111, and the obtained ready-made information and the keyword previously registered in the determination keyword table 1212 are collated with each other. When the coincidence is obtained, and a counter prepared for each stakeholder type is incremented by one. For example, when the keyword of “invention” is detected, the counter of the “foreseeing person” is incremented by one. The related information and the keyword are collated with each other, and the stakeholder type having the most counter value is set to a stakeholder type candidate of the stakeholder. The final determination is made based on the obtained analysis result and other pieces of ready-made information.

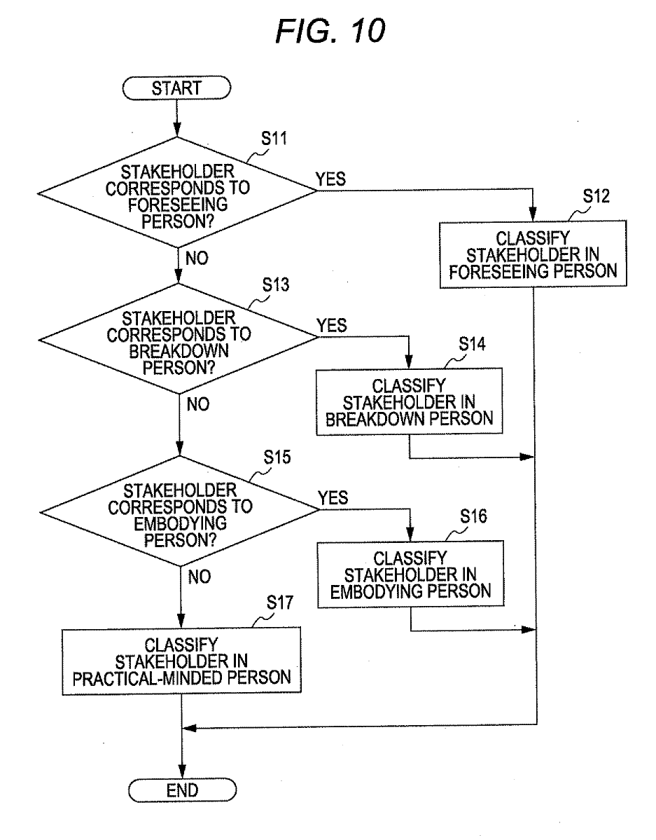

FIG. 10 is a flowchart illustrating a procedure of cluster classification processing of the embodiment.

The ready-made information on each stakeholder is searched to start the processing.

In operation S11 it is checked whether the stakeholder type is the foreseeing person. The determination whether the stakeholder type is the foreseeing person is made based on “whether the number of published papers is at least one”, “whether the number of innovative statements or responds is at least three in the Internet bulletin board”, “whether the number of proposals of an innovative plan is at least two”, or “it is determined by the keyword determination that the stakeholder type is the foreseeing person”. The processing goes to operation S12 when the determination that the stakeholder type is the foreseeing person is made, and the processing goes to Operation S13 when the determination that the stakeholder type is the foreseeing person is not made.

(In operation S12 because the stakeholder type is classified into the foreseeing person, “1” is registered in the foreseeing person 1213c of the cluster table 1213 while related to the corresponding stakeholder number of the stakeholder and the project number, and the processing is ended.

(In operation S13 because the stakeholder type is not the foreseeing person, it is checked whether the stakeholder type is the breakdown person. The determination whether the stakeholder type is the breakdown person is made based on “no relationship with the system becoming the requirement definition target”, “whether the number of aggressive statements is at least two in the Internet bulletin board”, or “it is determined by the keyword determination that the stakeholder type is the breakdown person”. The processing goes to Operation S14 when the determination that the stakeholder type is the breakdown person is made, and the processing goes to Operation S15 when the determination that the stakeholder type is the breakdown person is not made.

In operation S14 because the stakeholder type is classified into the breakdown person, “1” is registered in the breakdown person 1213f of the cluster table 1213 while related to the corresponding stakeholder number of the stakeholder and the project number, and the processing is ended.

In operation S15 because the stakeholder type is not the breakdown person, it is checked whether the stakeholder type is the embodying person. The determination whether the stakeholder type is the embodying person is made based on “at least two skills or qualifications concerning system construction becoming the requirement definition target” or “it is determined by the keyword determination that the stakeholder type is the breakdown person”. The processing goes to Operation S16 when the determination that the stakeholder type is the embodying person is made, and the processing goes to Operation S17 when the determination that the stakeholder type is the embodying person is not made.

In operation S16 because the stakeholder type is classified into the embodying person, “1” is registered in the embodying person 1213d of the cluster table 1213 while related to the corresponding stakeholder number of the stakeholder and the project number, and the processing is ended.

In operation S17 because the stakeholder type is not the embodying person, the stakeholder type is classified to be the practical-minded person, and “1” is registered in the practical-minded person 1213e of the cluster table 1213 while related to the corresponding stakeholder number of the stakeholder and the project number, and the processing is ended.

The stakeholder type determined by the above-described processing procedure is registered in the cluster table 1213 while related to the stakeholder number and the project number. The above-described processing procedure is an example, and the classification conditions are set as appropriate.

Thus, the stakeholder determination unit 1110 performs the stakeholder extraction and cluster classification. The stakeholder table 1211 concerning the stakeholder and the cluster table 1213 indicating the cluster classification of the stakeholder are set, and the processing is taken over by the cluster distribution generating and display unit 1120.

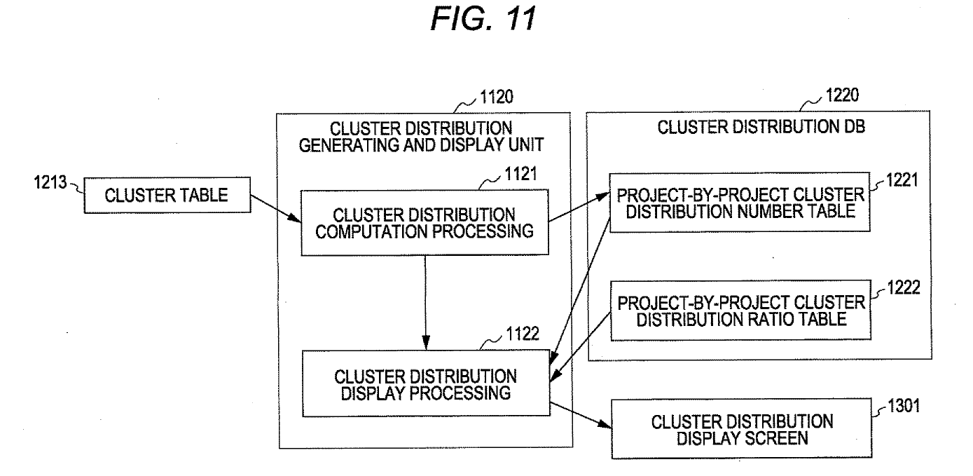

FIG. 11 illustrates a processing flow of the cluster distribution generating and display unit of the embodiment.

The cluster distribution generating and display unit 1120 performs cluster distribution computation processing 1121 and cluster distribution display processing 1122 based on the cluster table 1213 generated by the stakeholder determination unit 1110. In the cluster distribution computation processing 1121, the stakeholder cluster distribution is computed. In the cluster distribution display processing 1122, the display screen is displayed based on the computed cluster distribution if needed.

In the cluster distribution computation processing 1121, the cluster table 1213 is read to aggregate the number of cluster-by-cluster stakeholders in each project. For example, on the basis of the cluster table 1213 shown in FIG. 9, the foreseeing person and breakdown person are incremented by one for the project number of “1”, respectively. The aggregation of each cluster is registered in the project-by-project cluster distribution number table 1221 while related to the project number.

Using the number of persons in each computed cluster, the number ratio of each cluster is computed while the total number of stakeholder of each project computed by the stakeholder determination unit 1110 is set to a modulus. The computed number ratio is also registered in a project-by-project cluster distribution ratio table 1222 while related to the project number.

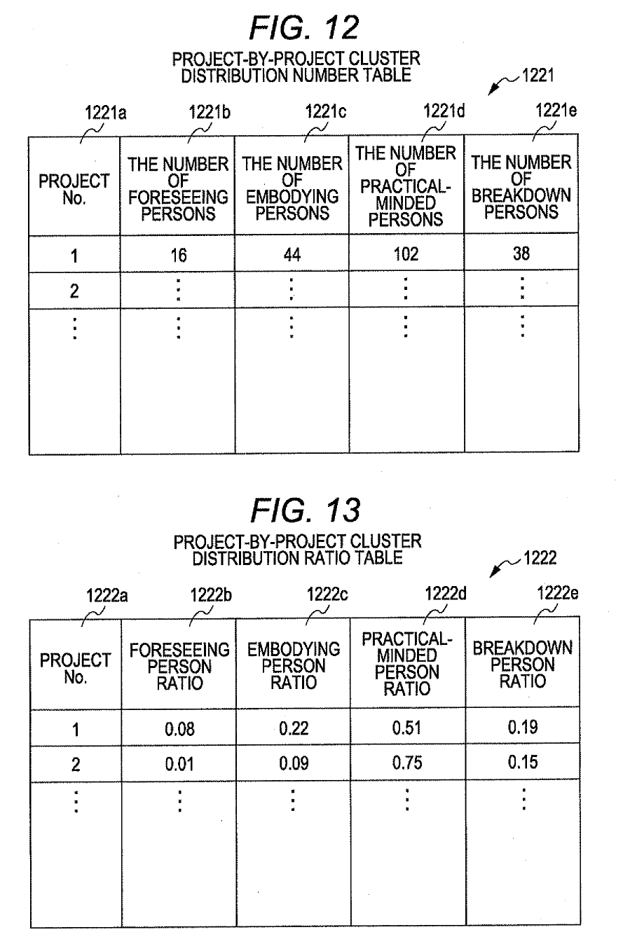

FIG. 12 illustrates an example of a project-by-project cluster distribution number table.

The number of persons of each cluster, the number of foreseeing persons 1221b, the number of embodying persons 1221c, the number of practical-minded persona 1221d, and the number of breakdown persons 1221e are registered in a project-by-project cluster distribution number table 1221 while related to a project number 1221a.

FIG. 13 illustrates an example of a project-by-project cluster distribution ratio table.

The number of persons of each cluster, a foreseeing person ratio 1222b, an embodying person ratio 1222c, a practical-minded person ratio 1222d, and a breakdown person ratio 1222e are registered in the project-by-project cluster distribution ratio table 1222 while related to a project number 1222a.

In the cluster distribution display processing 1122, the cluster distribution display screen is displayed on the display device based on the project-by-project cluster distribution number table 1221 and project-by-project cluster distribution ratio table 1222 which are registered through the cluster distribution computation processing 1121. The cluster distribution display screen is displayed on the monitor 108 of the requirement confirmation support apparatus 100 or the display data is transmitted to a computer which makes a request through the network 300. The computer causes the monitor connected to the computer to display the display screen based on the display data.

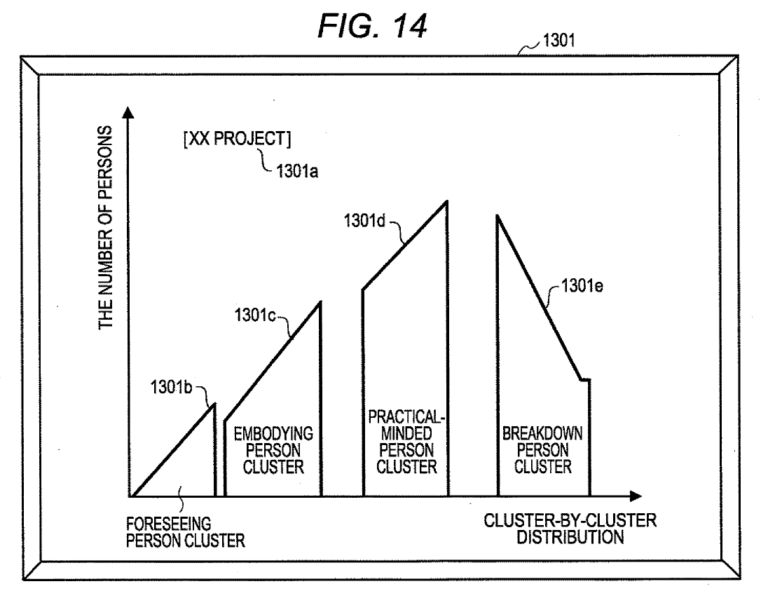

FIG. 14 illustrates an example of a cluster distribution display screen.

A project name 1301a, the number of persons of the foreseeing person cluster 1301b involved in the project, the number of persons of the embodying person cluster 1301c, the number of persons of the practical-minded person cluster 1301d, and the number of persons of the breakdown person cluster 1301e are displayed with a graph in a cluster distribution display screen 1301.

The cluster distribution generating and display unit 1120 computes the cluster distribution, and the project-by-project cluster distribution number table 1221 and the project-by-project cluster distribution ratio table 1222 are set in the cluster distribution DB 1220 to display the cluster distribution display screen 1301. The user can understand the cluster distribution status at that time based on the display screen.

Processing performed by the requirement defining model selecting unit 1130 will be described below.

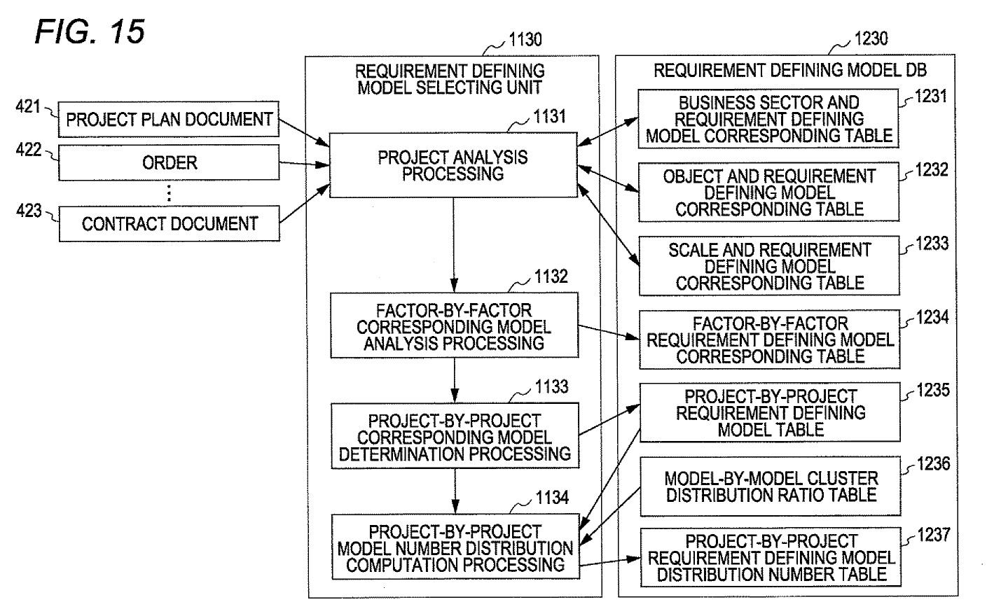

FIG. 15 illustrates a processing flow of the requirement defining model selecting unit of the embodiment.

The requirement defining model selecting unit 1130 sequentially performs project analysis processing 1131, factor-by-factor corresponding model analysis processing 1132, project-by-project corresponding model determination processing 1133, and project-by-project model number distribution computation processing 1134 to select the requirement defining model suitable to the target project.

In the project analysis processing 1131, a project plan document 421, an order 422, and a contract document 423 etc. concerning the corresponding project are collected from the ready-made information DB 410, and business sector information described therein and previously-set business sector keywords are compared to each other to set a business sector and requirement defining model corresponding table 1231. Similarly, object information described in the project plan document 421, order 422, and contract document 423 etc. and previously-set object keywords are compared to each other to set an object and requirement defining model corresponding table 1232. The user scale described in the project plan document 421, order 422, and contract document 423 etc. and previously-set scale keywords are compared to each other to set a scale and requirement defining model corresponding table 1233.

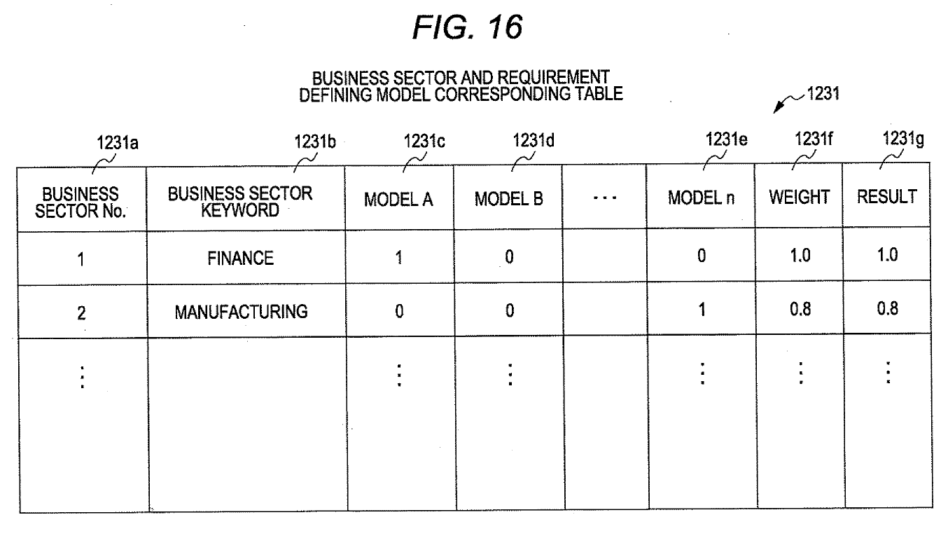

FIG. 16 illustrates an example of the business sector and requirement defining model corresponding table.

A business sector keyword 1231b and a correspondence relationship between the business sector keyword and each model are set in the business sector and requirement defining model corresponding table 1231 while related to a business sector number 1231a. A weighting factor (weight in FIG. 16) 1231f and a result 1231g are also set in the business sector and requirement defining model corresponding table 1231.

The business sector number 1231a, business sector keyword 1231b, correspondence information on the model (model A1231c, model B1231d, and model n1231e), and weight 1231f are set before the project analysis processing 1131 is performed. “1” is set to the correspondence information on the model when the model is suitable to the corresponding business sector keyword. In the project analysis processing 1131, the business sector information described in the project plan document 421, order 422, and contract document 423 and the business sector keyword 1231b are collated with each other. The correspondence information on the model is directly retained when the coincidence is obtained, and the correspondence information on the model is set to “0” when the coincidence is not obtained. For example, when the business sector keyword 1231b of “finance” is detected, “1” set to the model A1231c is retained. When the business sector keyword 1231b of “finance” is not detected, the “0” is set to the model A 1231c. The collation is performed for all the business sector keywords 1231b, the obtained correspondence information on the model and the weight 1231f are multiplied, and the computation result is registered in a result 1231g. For example, in the above-described example, when the business sector keyword 1231b of “finance” is detected while “1” is set to the model A 1231c, the weight 1231f of “1.0” is multiplied to obtain the result 1231g of “1.0”. When “0” is set to the model A 1231c, the result 1231g becomes “0.0”.

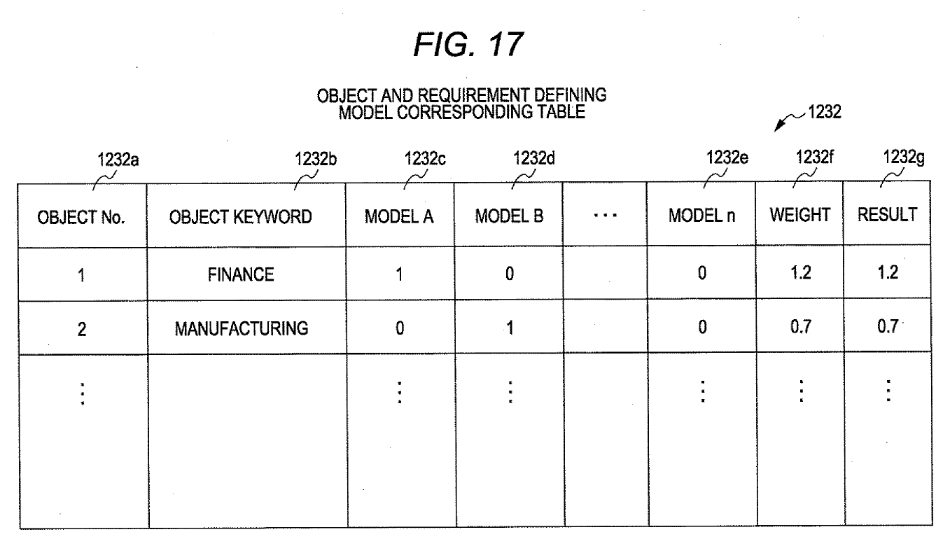

FIG. 17 illustrates an example of the object and requirement defining model corresponding table.

An object keyword 1232b and the correspondence relationship between the business sector keyword and each model are set in the object and requirement defining model corresponding table 1232 while related to an object number 1232a. A weight 1232f and a result 1232g are also set in the object and requirement defining model corresponding table 1232. In the object and requirement defining model corresponding table 1232, the information setting in each item is similar to that of the business sector and requirement defining model corresponding table 1231 except that the business sector keyword 1231b is replaced by the object keyword 1232b.

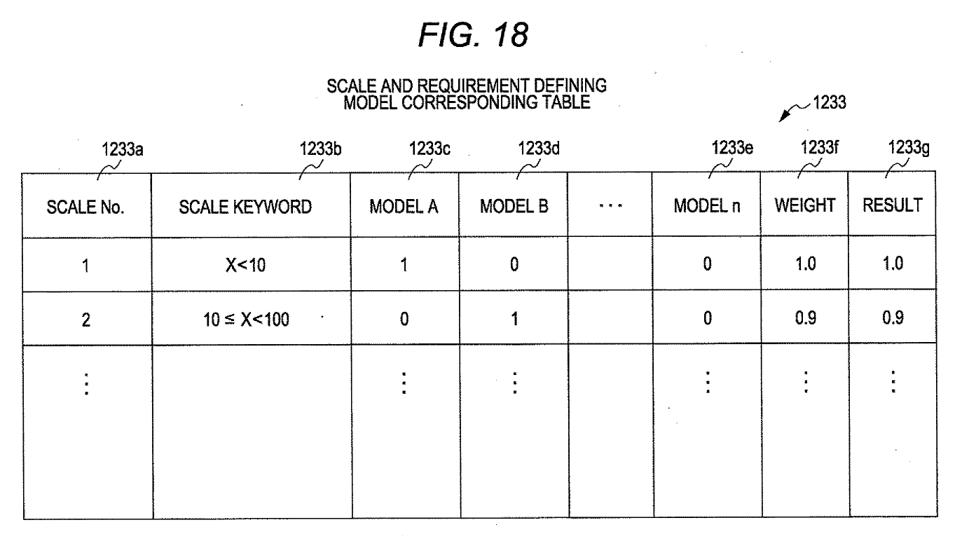

FIG. 18 illustrates an example of the scale and requirement defining model corresponding table.

A scale 1233b and a correspondence relationship between the scale 1233b and each model are set in the scale and requirement defining model corresponding table 1233 while related to a scale number 1233a. A weight 1233f and a result 1233g are also set in the scale and requirement defining model corresponding table 1233. In the scale and requirement defining model corresponding table 1233, the information setting in each item is similar to that of the business sector and requirement defining model corresponding table 1231 except that the business sector keyword 1231b is replaced by the scale 1233b.

Thus, the business sector and requirement defining model corresponding table 1231, the object and requirement defining model corresponding table 1232, and the scale and requirement defining model corresponding table 1233 are set from the pieces of described information such as the project plan document 421, order 422, and business sector 423.

In the factor-by-factor corresponding model analysis processing 1132, on the basis of the business sector and requirement defining model corresponding table 1231, object and requirement defining model corresponding table 1232, and scale and requirement defining model corresponding table 1233, numerical values of the models set in the corresponding tables are added to evaluate goodness of fit of the model. For example, in the business sector and requirement defining model corresponding table 1231 of FIG. 16, the results 1231g of the rows having the numerical value of “1” are added in the column of model A 1231c to compute the evaluation of the model A concerning the business factor The computation result is stored in a factor-by-factor requirement defining model corresponding table 1234. The model having the highest numerical value is selected and weighted.

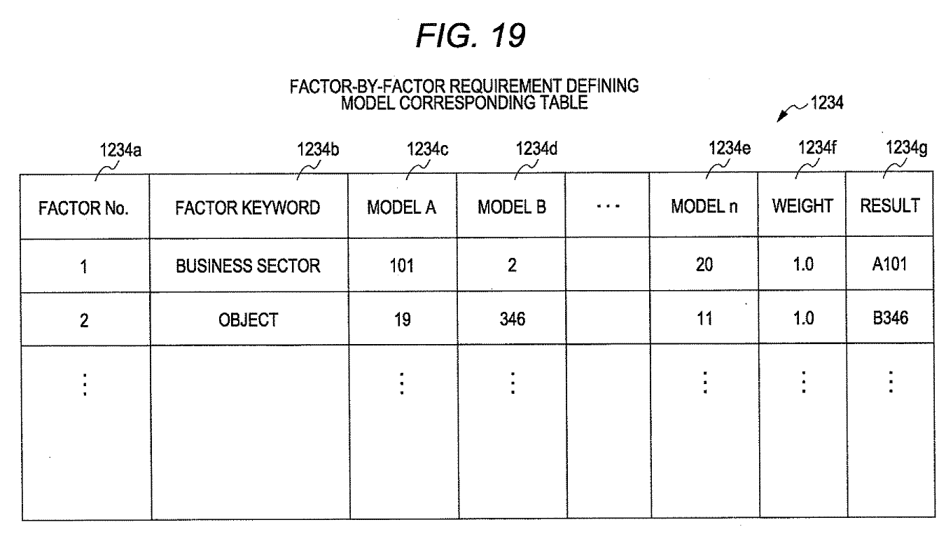

FIG. 19 illustrates an example of the factor-by-factor requirement defining model corresponding table.

A factor number 1234a, goodness of fit of the model computed in each factor (in this case, the business sector, object, and scale) in the above-described procedure, a weight 1234f, and a result 1234g are set in the factor-by-factor requirement defining model corresponding table 1234. The goodness of fit of the model, the weight 1234f, and the result 1234g are related to the factor number 1234a. For example, in the “business sector” of a factor 1234b, the model A 1234c has the highest evaluation value of “101”, and the result of which the weight of “1.0” and the evaluation value of “101” are multiplied is set to the result 1234g. In this case, the information indicating that “the evaluation value of 101 in the model A” is set in the result 1234g. Similarly, in the “object” of the factor 1234b, the model B 1234d has the highest evaluation value, and the information indicating that “the evaluation value of 346 in the model B” is set in the result 1234g.

In the project-by-project corresponding model determination processing 1133, the requirement defining model suitable to the project is selected based on the factor-by-factor requirement defining model corresponding table 1234 which is of the result of the factor-by-factor corresponding model analysis processing 1132. At this point, the model having the largest result 1234g is set to the requirement defining model of the project. In FIG. 19, “the evaluation value of 101 in the model A” and “the evaluation value of 346 in the model B” are compared to each other, and the “the evaluation value of 346 in the model B” is selected. The selection result is registered in a project-by-project requirement defining model table 1235.

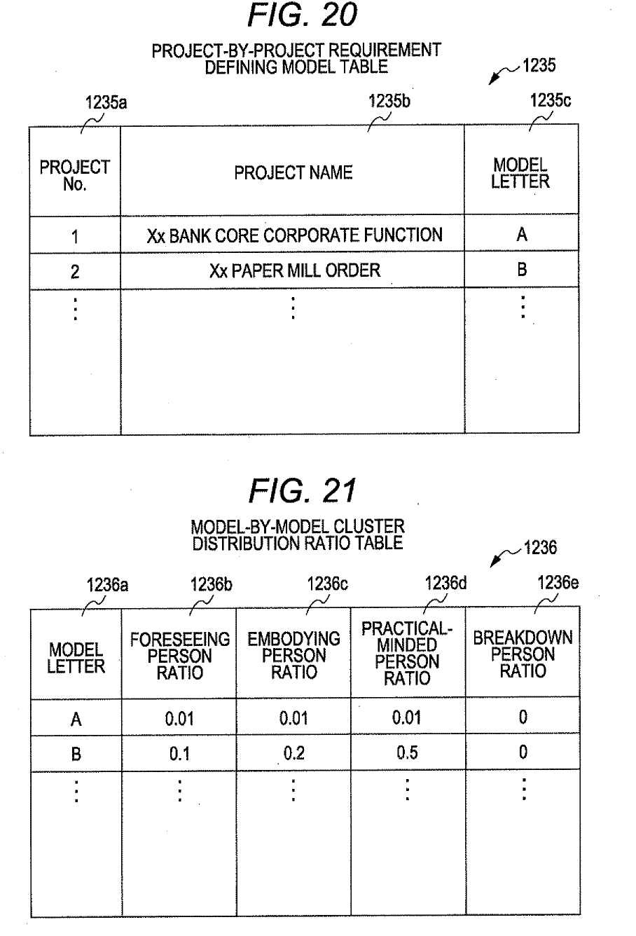

FIG. 20 illustrates an example of the project-by-project requirement defining model table.

A project name 1235b and a selected model letter 1235c are registered in the project-by project requirement defining model table 1235 while related to a project number 1235a. A first line of FIG. 20 indicates that the model “A” is selected for a “XX bank core corporate function” of the project number of “1”.

Then, in the project-by-project model number distribution computation processing 1134, the model selected in each project is determined by referring to the project-by-project requirement defining model table 1235 registered through the project-by-project corresponding model determination processing 1133. On the basis of the requirement defining model of the project, the number of cluster distribution persons is computed by referring to a model-by-model cluster distribution ratio table 1236 previously set for the determined model, and the number of cluster distribution persons is registered in a project-by-project requirement defining model distribution number table 1237.

FIG. 21 illustrates an example of the model-by-model cluster distribution ratio table.

A foreseeing person ratio 1236b, an embodying person ratio 1236c, a practical-minded person ratio 1236d, and a breakdown person ratio 1236e in each cluster are registered in the model-by-model cluster distribution ratio table 1236 while related to a model letter 1236a.

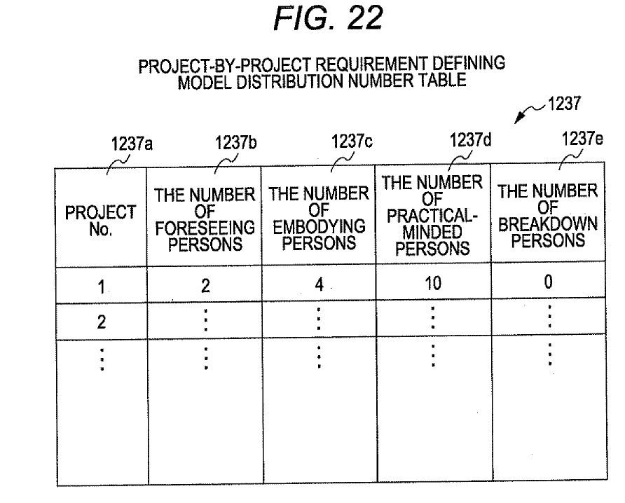

FIG. 22 illustrates an example of the project-by-project requirement defining model distribution number table.

On the basis of the cluster distribution ratio set in the selected model, the number of persons of each cluster, the number of foreseeing persons 1237b, the number of embodying persons 1237c, the number of practical-minded persons 1237d, and the number of breakdown persons 1237e are set in the project-by-project requirement defining model distribution number table 1237 while related to a project number 1237a.

Thus, the requirement defining model selecting unit 1130 performs the project analysis and the processing for selecting the model most suitable to the project. The project-by-project requirement defining model table 1235 in which the selected model is registered and the project-by-project requirement defining model distribution number table 1237 indicating the cluster distribution of the model are set, and the processing is taken over by the requirement defining model generating and display unit 1140. Alternatively, the processing till the model is selected may be performed by the requirement defining model selecting unit 1130, and the project-by-project model number distribution computation processing 1 134 may be performed by the requirement defining model generating and display unit 1140.

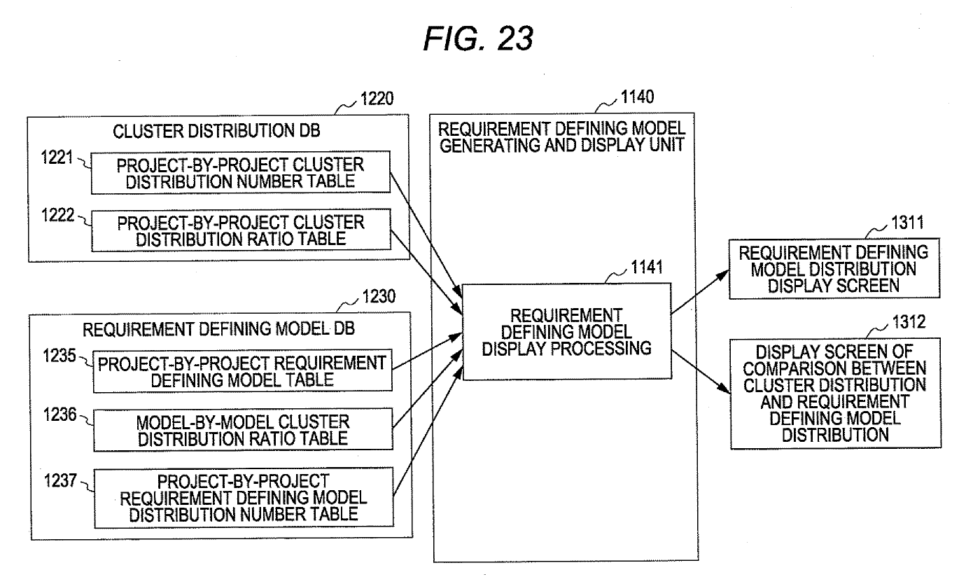

FIG. 23 illustrates a processing flow of the requirement defining model generating and display unit of the embodiment.

The requirement defining model generating and display unit 1140 performs requirement defining model display processing 1141 for displaying the actual stakeholder cluster distribution generated by the cluster distribution generating and display unit 1120 and the stakeholder cluster distribution model. The stakeholder cluster distribution model is based on the requirement defining model selected by the requirement defining model selecting unit 1130.

In the requirement defining model display processing 1141, a defining model distribution display screen 1311 is displayed based on the project-by-project requirement defining model table 1235, model-by-model cluster distribution ratio table 1236, and project-by-project requirement defining model distribution number table 1237 which are generated by the requirement defining model selecting unit 1130 and stored in the requirement defining model DB 1230. The requirement defining model distribution display screen 1311 indicates a cluster number distribution based on the requirement defining model.

Additionally, in the requirement defining model display processing 1141, the project-by-project cluster distribution number table 1221 and project-by-project cluster distribution ratio table 1222 which are generated by the cluster distribution generating and display unit 1120 and stored in the cluster distribution DB 1220 are added to a display screen 1312 of comparison between cluster distribution and project-by-project requirement defining model distribution.

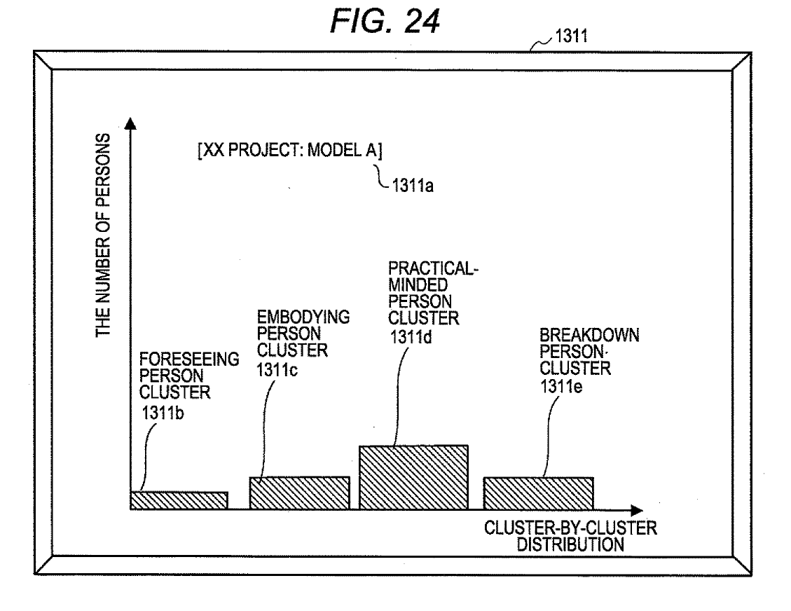

FIG. 24 illustrates an example of the requirement defining model distribution display screen.

In the requirement defining model distribution display screen 1311, the number of persons of the foreseeing person cluster 1311b, the number of persons of the embodying person cluster 1311c, the number of persons of the practical-minded person cluster 1311d, and the number of persons of the breakdown person cluster 1311e which are computed based on the requirement defining model (in this case, model A) are displayed with a graph along with a project name and selected model name 1311a.

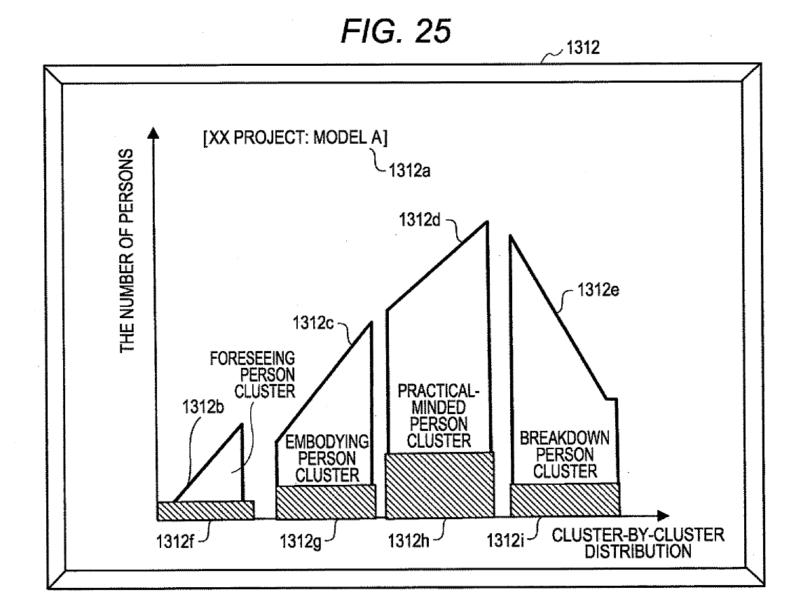

FIG. 25 illustrates a display screen of comparison between a cluster distribution and a requirement defining model distribution.

In the display screen 1312 of comparison between cluster distribution and project-by-project requirement defining model distribution, the number of actual persons of the foreseeing person cluster 1312b, the number of actual persons of embodying person cluster 1312c, the number of actual persons of the practical-minded person cluster 1312d, and the number of actual persons of breakdown person cluster 1312e which are based on the actual cluster distribution, and the number of persons of the foreseeing person cluster 1312f, the number of persons of the embodying person cluster 1312g, the number of persons of the practical-minded person cluster 1312h, and the number of persons of the breakdown person cluster 1312i which are computed based on the requirement defining model (in this case, model A) are displayed with a graph along with a project name and selected model name 1312a while overlapping each other. That is, the cluster distribution display screen 1301 of FIG. 14 and the requirement defining model distribution display screen 1311 of FIG. 24 overlap each other in the display screen of FIG. 25.

Thus, which cluster the stakeholder is lessened can easily be understood by comparing the actual cluster distribution and the cluster distribution based on the requirement definition. The optimum representative configuration can be formed by bringing the cluster distribution to the model distribution ratio. Which screen of FIG. 24 or 25 is displayed can arbitrarily selected by a menu.

The representative involved in the requirement definition can be selected with the proper stakeholder configuration by the above-described procedure. In the requirement defining process, a process of obtaining the consensus on the presented requirement definition is performed among the selected stakeholders. The following pieces of processing are processing for supporting the consensus formation. First, satisfaction level measuring processing will be described.

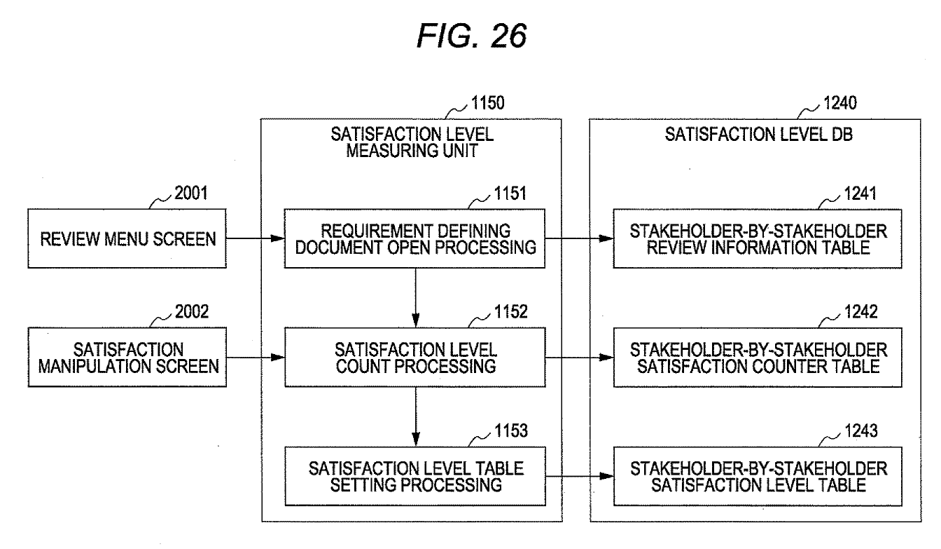

FIG. 26 illustrates a processing flow of the satisfaction level measuring unit of the embodiment.

The satisfaction level measuring unit 1150 is connected through the network 300 to the terminal devices of each stakeholder, e.g., the stakeholder A terminal 210, the stakeholder B terminal 220, and the stakeholder C terminal 230. A review menu screen 2001 and a satisfaction manipulation screen 2002 are displayed on the display device of each terminal to measure the stakeholder satisfaction level. Therefore, the satisfaction level measuring unit 1150 sequentially performs requirement defining document open processing 1151, satisfaction level count processing 1152, and satisfaction level table setting processing 1153.

In the requirement defining document open processing 1151, the requirement defining document in which the requirements are defined is opened in an “online review menu” on the Internet. The review menu screen 2001 on which the “online review menu” is displayed is displayed on the display screen of the terminal based on the display data transmitted to the terminal from the satisfaction level measuring unit 1150. When the stakeholder is authenticated, the satisfaction manipulation screen 2002 is displayed on which the requirement definition is displayed.

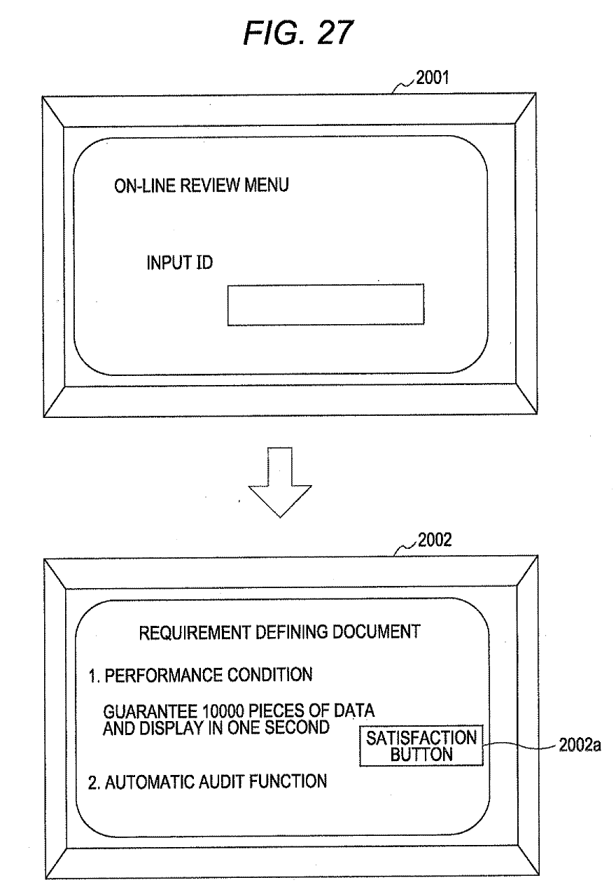

FIG. 27 illustrates examples of the review menu screen and satisfaction manipulation screen.

A title of the “online review menu” and an ID input field are displayed in the review menu screen 2001. When the stakeholder inputs an ID, the ID is transmitted to the requirement confirmation support apparatus 100 through the network.

When the ID is authenticated, the display screen is updated into the satisfaction manipulation screen 2002 in the requirement defining document open processing 1151. The requirement definition is displayed in the satisfaction manipulation screen 2002, and a satisfaction button 2002a is displayed in each requirement defining item. When the stakeholder manipulates the satisfaction button 2002a, the corresponding requirement defining item and manipulation status such as the number of button manipulations are transmitted to the requirement confirmation support apparatus 100 through the network.

The requirement defining document open processing 1151 will be described again. In the requirement defining document open processing 1151, when the stakeholder ID set in the review menu screen 2001 is obtained, the ID and the stakeholder table 1211 are collated with each other to specify the stakeholder. Then, review information is registered in a stakeholder-by-stakeholder review information table 1241.

FIG. 28 illustrates an example of the stakeholder-by-stakeholder review information table.

The number of reviews 1241b, a review data and time 1241c, a start time 1241d, and an end time 1241e are registered in the stakeholder-by-stakeholder review information table 1241 while related to a stakeholder number 1241a. In FIG. 28, the first and second reviews are registered for the stakeholder specified by the stakeholder number 1241a of “1”.

In the satisfaction level count processing 1152, when the stakeholder manipulates the satisfaction manipulation screen 2002, manipulation information is obtained that indicates how many times the satisfaction button corresponding to each requirement is clicked. The obtained manipulation information is related to the stakeholder number and registered in the stakeholder-by-stakeholder satisfaction counter table 1242.

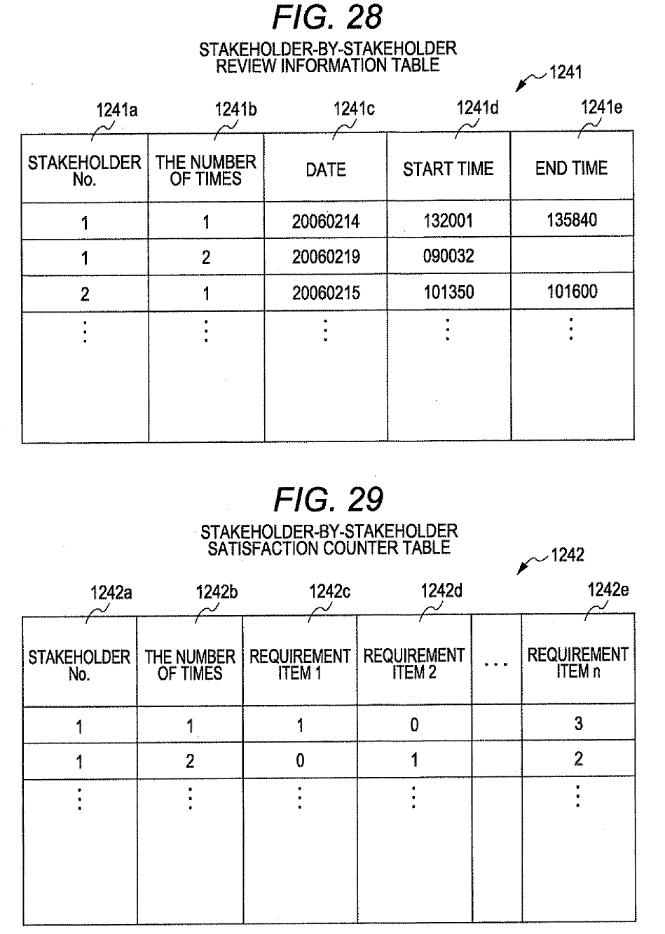

FIG. 29 illustrates an example of the stakeholder-by-stakeholder satisfaction counter table.

The number of reviews 1242b and the number of clicks of each requirement item are registered in the stakeholder-by-stakeholder satisfaction counter table 1242 while related to a stakeholder number 1242a. When the requirement definition corresponding to a requirement item 1 is clicked, the number of clicks is registered in the requirement item 1 (1242c). Similarly, the numbers of clicks are registered in a requirement item 2 (1242d) and a requirement item n (1242e), respectively. For example, in the registration of the stakeholder having the stakeholder number of “1”, the requirement item 1 is clicked once and the requirement item n is clicked three times in the first review. It is considered that the stakeholder is sufficiently satisfied as the number of clicks is increased. The information is referred to in the later analysis processing if needed.

In the satisfaction level table setting processing 1153, the stakeholder-by-stakeholder satisfaction level is computed based on the stakeholder-by-stakeholder satisfaction counter table 1242, and is then registered in a stakeholder-by-stakeholder satisfaction level table 1243 Because the number of clicks is counted in the stakeholder-by-stakeholder satisfaction counter table 1242, it is necessary that the number of clicks be converted into information indicating whether the satisfaction is obtained in order to compute how many stakeholders agree the requirement item. Therefore, when the stakeholder-by-stakeholder satisfaction counter table 1242 has the count value of “0”, the satisfaction level of the corresponding stakeholder-by-stakeholder satisfaction level table 1243 is set to “0 (not satisfied)”. When the stakeholder-by-stakeholder satisfaction counter table 1242 has a count value except for “0”, the satisfaction level is set to “1 (satisfied)”.

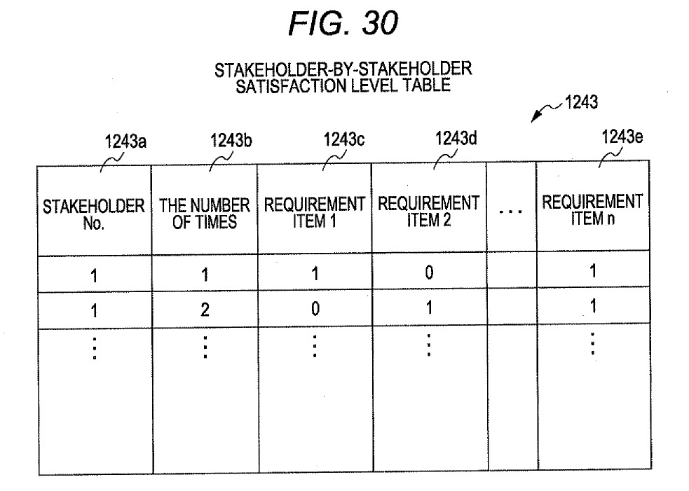

FIG. 30 illustrates an example of the stakeholder-by-stakeholder satisfaction level table.

The number of reviews 1243b and the satisfaction level of each requirement item are registered in the stakeholder-by-stakeholder satisfaction level table 1243 while related to a stakeholder number 1243a. Whether the stakeholder is satisfied with a requirement item 1 is registered in a requirement item 1 (1243c). Similarly, the satisfaction levels are registered in a requirement item 2 (1243d) and a requirement item n (1243e).

Thus, the satisfaction level measuring unit 1150 measures the satisfaction level of each stakeholder, and the stakeholder-by-stakeholder review information table 1241, the stakeholder-by-stakeholder satisfaction counter table 1242, and the stakeholder-by-stakeholder satisfaction level table 1243 are stored in the satisfaction level DB 1240. Then, the cluster-by-cluster satisfaction level generating and display unit 1160 is started up.

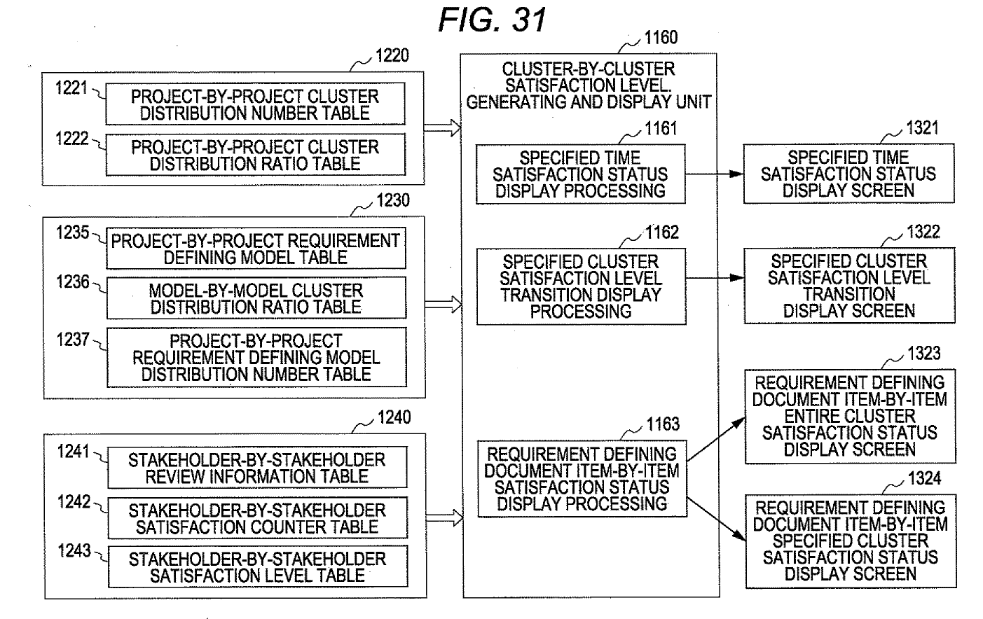

FIG. 31 illustrates a processing flow of the cluster-by-cluster satisfaction level generating and display unit of the embodiment.

The cluster-by-cluster satisfaction level generating and display unit 1160 performs the displays for supporting the confirmation work based on the generated project-by-project cluster distribution number table 1221, project-by-project cluster distribution ratio table 1222, project-by-project requirement defining model table 1235, model-by-model cluster distribution ratio table 1236, project-by-project requirement defining model distribution number table 1237, stakeholder-by-stakeholder review information table 1241, stakeholder-by-stakeholder satisfaction counter table 1242, and stakeholder-by-stakeholder satisfaction level table 1243. Specifically, the cluster-by-cluster satisfaction level generating and display unit 1160 performs specified time satisfaction status display processing 1161 for displaying a specified time satisfaction status display screen 1321, specified cluster satisfaction level transition display processing 1162 for displaying a specified cluster satisfaction level transition display screen 1322, and requirement defining document item-by-item satisfaction status display processing 1163 for displaying a requirement defining document item-by-item entire cluster satisfaction status display screen 1323 and a requirement defining document item-by-item specified cluster satisfaction status display screen 1324. In each piece of processing, the processing for displaying the specified screen is started up according to menu specification performed by a user.

In the specified time satisfaction status display processing 1161 when certain time (date and time specification) is specified, the information closest to the specified time in the past from the specified time is searched and displayed as a specified time satisfaction status. The specified time and a date 1241c and a start time 1241d of the stakeholder-by-stakeholder review information table 1241 are collated with each other, and the satisfaction levels concerning the review prior to the specified time are aggregated and displayed in each cluster.

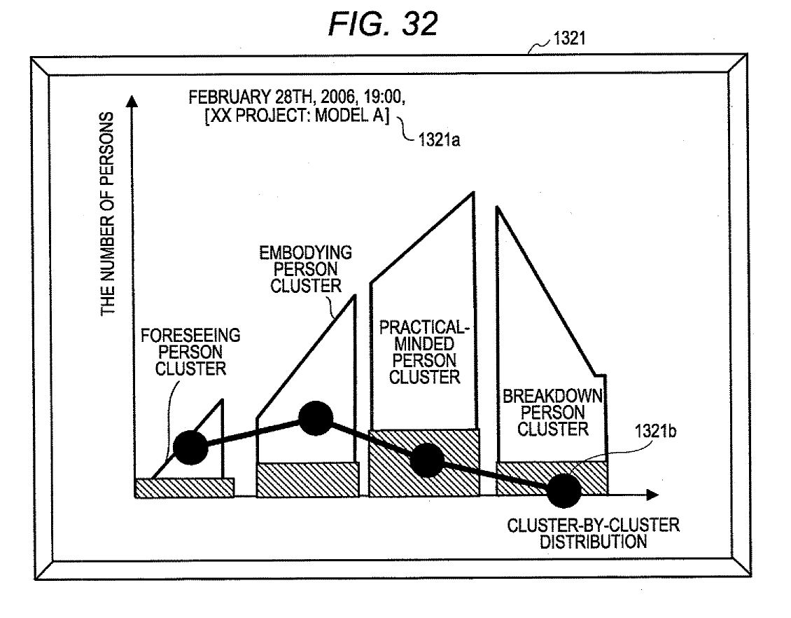

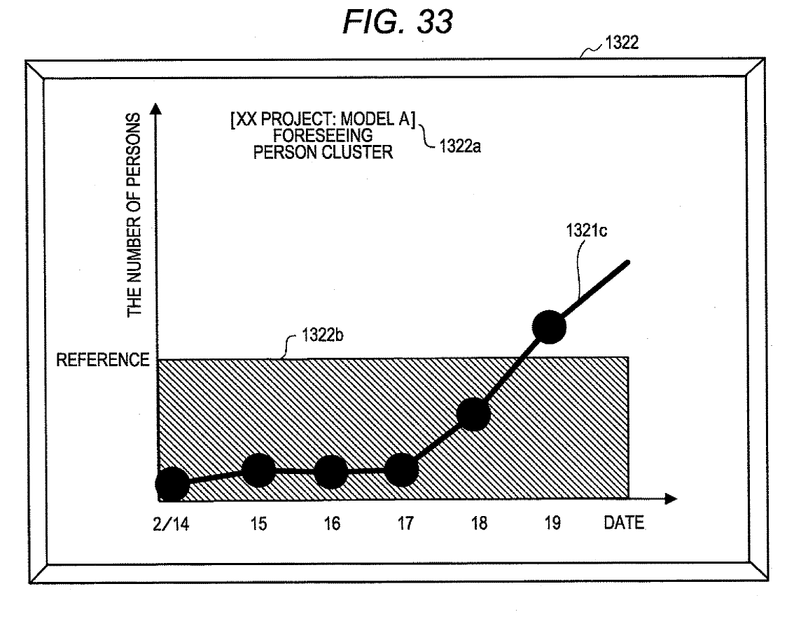

FIG. 32 illustrates an example of the specified time satisfaction status display screen.

A project name and specified time 1321a as well as a satisfaction level distribution 1321b are displayed in the specified time satisfaction status display screen 1321. In FIG. 32, the actual cluster distribution and the cluster distribution on the model are also displayed while superposed on the satisfaction level distribution 1321b.

The progress of the requirement confirmation work can easily be confirmed by displaying the actual cluster distribution and the cluster distribution on the model while superposing the actual cluster distribution and the cluster distribution on the model on the satisfaction level distribution 1321b. For example, in FIG. 32, it can be seen that the high satisfaction level is obtained from the embodying person while the stakeholder belonging to the crowded practical-minded person cluster has the low satisfaction level.

In the specified cluster satisfaction level transition display processing 1162, when the cluster, a period (start date and end data), a unit (day or month) are specified to input a display request, the stakeholder-by-stakeholder review information table 1241 is searched to aggregate the corresponding stakeholder-by-stakeholder satisfaction level table 1243 for the stakeholder belonging to the specified cluster in the specified period, so that transition of the satisfaction level is displayed.

FIG. 33 illustrates an example of a specified cluster satisfaction level transition display screen.

A project name and cluster name 1322a as well as a satisfaction level 1321c of each day in the specified period (in FIG. 33, February 14 to February 19) are displayed in a specified cluster satisfaction level transition display screen 1322. A reference 1322b indicates a reference value at which the consensus is obtained for the cluster. The reference value is computed based on the requirement defining model. For example, it is set how many ratios the stakeholder is satisfied in the number of stakeholders of the cluster computed by the cluster distribution ratio of the requirement defining model. The reference value is computed based on the ratio.

The change in satisfaction status and a speed can be confirmed from the specified cluster satisfaction level transition display screen.

In the requirement defining document item-by-item satisfaction status display processing 1143, when the data is specified to request the display of the requirement defining document item-by-item entire cluster satisfaction status display screen, the satisfaction level concerning the review prior to the specified data is computed in each of the requirement and cluster to display a requirement defining document item-by-item entire cluster satisfaction status display screen 1323.

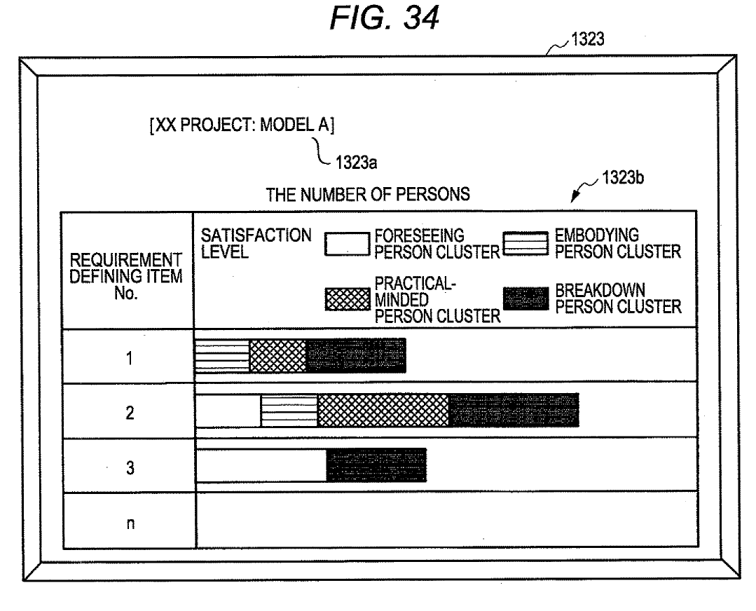

FIG. 34 illustrates an example of the requirement defining document item-by-item entire cluster satisfaction status display screen.

On the requirement defining document item-by-item entire cluster satisfaction status display screen 1323, a project name 1323a and the satisfaction levels of the stakeholders belonging to all the clusters are displayed in each requirement defining item. In FIG. 34, the satisfaction levels are graphed in each of the foreseeing person cluster, embodying person cluster, practical-minded person cluster, and breakdown person.

In the requirement defining document item-by-item satisfaction status display processing 1143, when the data and cluster are specified to request the display of the requirement defining document item-by-item specified cluster satisfaction status display screen, the satisfaction level concerning the review prior to the specified data is computed in each requirement defining item for the specified cluster to display a requirement defining document item-by-item specified cluster satisfaction status display screen 1324.

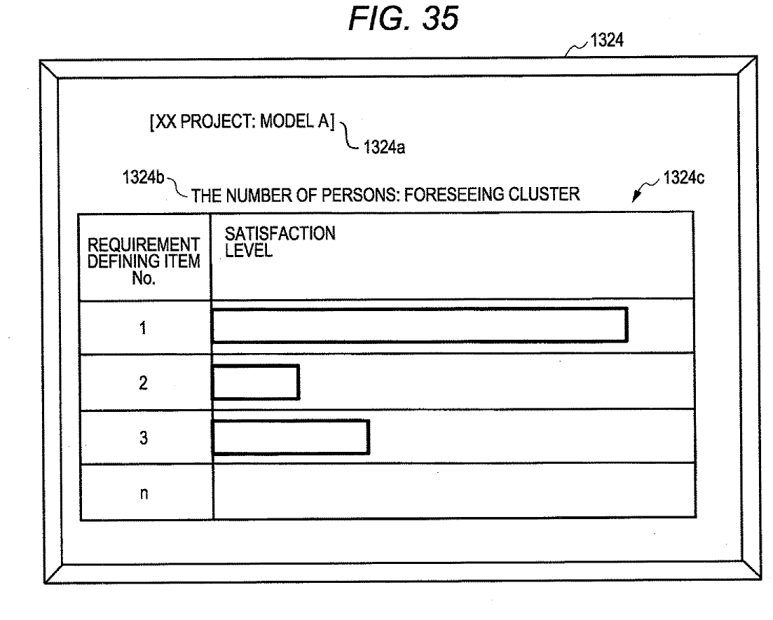

FIG. 35 illustrates an example of the requirement defining document item-by-item specified cluster satisfaction status display screen.

In the requirement defining document item-by-item specified cluster satisfaction status display screen 1324, a project name 1324a, a specified cluster name 1324b, and a satisfaction level 1324c of the stakeholder belonging to the specified cluster are displayed in each requirement defining item. In FIG. 35, the satisfaction levels of the foreseeing person cluster are graphed.

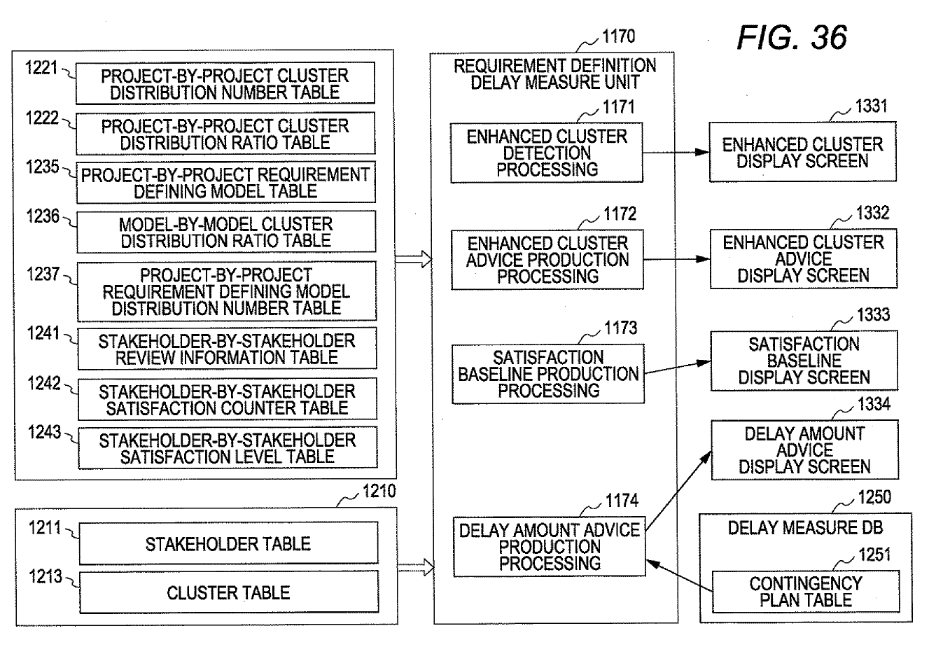

FIG. 36 illustrates a processing flow of the requirement definition delay measure unit of the embodiment.

The requirement definition delay measure unit 1170 comprehends the delay status of the requirement defining process to present the measure against the delay status if needed, based on the already-generated project-by-project cluster distribution number table 1221, project-by-project cluster distribution ratio table 1222, project-by-project requirement defining model table 1235, model-by-model cluster distribution ratio table 1236, project-by-project requirement defining model distribution number table 1237, stakeholder-by-stakeholder review information table 1241, stakeholder-by-stakeholder satisfaction counter table 1242, stakeholder-by-stakeholder satisfaction level table 1243, stakeholder table 1211, and cluster table 1213. Therefore, the requirement definition delay measure unit 1170 performs enhanced cluster detection processing 1171, enhanced cluster advice production processing 1172, satisfaction baseline production processing 1173, and delay amount advice production processing 1174. In each piece of processing, the processing for displaying the specified screen is started up according to menu specification performed by the user.

In the enhanced cluster production processing 1171, the model and the actual satisfaction level are compared to each other in each cluster to display an enhanced cluster display screen 1331 in which the cluster below the satisfaction level is highlighted with a mark.

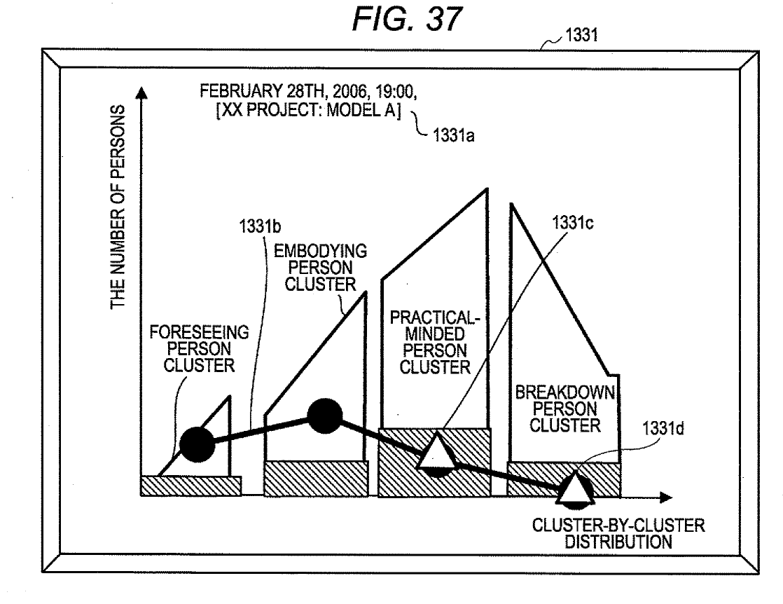

FIG. 37 illustrates an example of the enhanced cluster display screen.

On the enhanced cluster display screen 1331, a project name and specified time 1331a as well as the cluster distribution and a satisfaction level 1331b are displayed in each cluster on the cluster distribution model based on the requirement defining model. The clusters below the satisfaction level are indicated on the satisfaction level 1331b by marks 1331c and 1331d. In FIG. 37, it can be seen that the practical-minded person cluster and the breakdown person cluster are located below the satisfaction level. Therefore, the cluster requiring persuasion can be understood in order to increase the satisfaction level.

In the enhanced cluster advice production processing 1172, a name list and division of the stakeholders belonging to the cluster requiring the persuasion are displayed as an enhanced cluster advice display screen 1332 to be contributory to the measure based on the stakeholder table 1211 and the cluster table 1213.

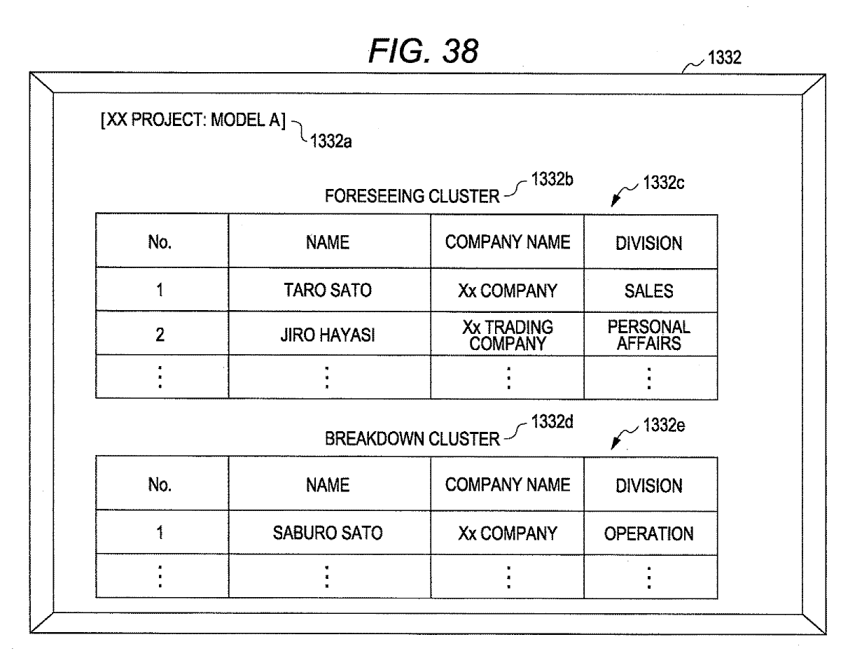

FIG. 38 illustrates an example of the enhanced cluster advice display screen.

A project name 1332a, cluster names 1332b and 1332d requiring the persuasion, and lists 1332c and 1332e of the stakeholders belonging to the cluster requiring the persuasion are displayed on the enhanced cluster advice display screen 1332. The user can refer to the enhanced cluster advice display screen 1332 to easily search the stakeholder requiring the persuasion.

In the satisfaction baseline production processing 1173, when one cluster is specified, the progress of the improvement of the average satisfaction level is computed for the model and displayed as a satisfaction baseline display screen 1333.

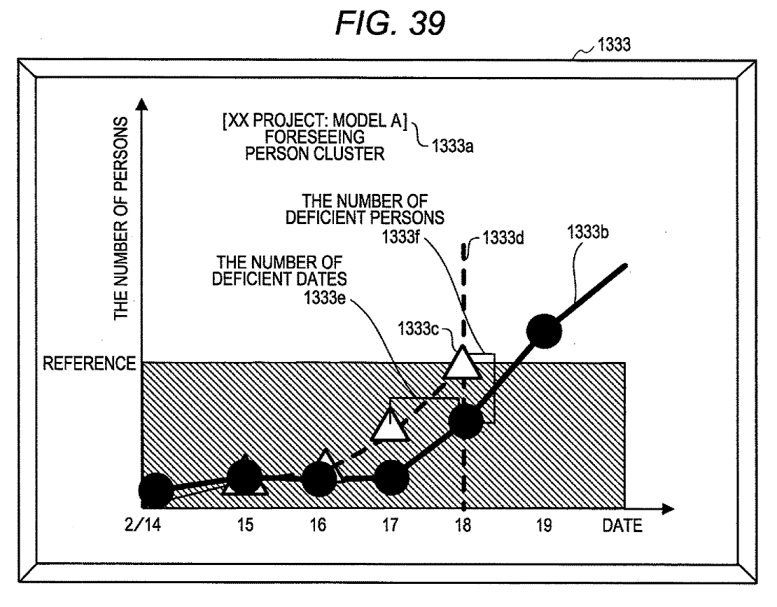

FIG. 39 illustrates an example of the satisfaction baseline display screen.

A project and cluster name 1322a as well as transition 1322b of the actual cluster satisfaction level are displayed on the satisfaction baseline display screen 1333. A satisfaction baseline 1322d is also displayed based on the model while superimposed on the transition 1322b. The satisfaction baseline 1322d indicates the transition of the average satisfaction level based on the model. From FIG. 39, the number of deficient dates 1322e and the number of deficient persons 1322f can be computed for the current satisfaction level. In the number of deficient dates 1322e, the number of persons being late is set through comparison with a modeled progress status. In the number of deficient persons 1322f, a difference between the number of persons supposed to be collected and the number of actual persons is set in a modeled progress status.

Thus, the current satisfaction level transition status 1322b and the modeled satisfaction level progress status are confirmed on the same screen, so that the completion data and the delay amount can roughly and easily be understood.

In the delay amount advice production processing 1174, the delay amount is displayed by the number of delay days, the number of deficient persons, and the completion data, the suitable measure is selected in the measures stored in a contingency plan table 1251, and the selected measure is displayed on the enhanced cluster advice display screen 1332. The suitable measure is selected based on a ratio of the number of deficient persons to the number of total persons and a ratio of the number of delay days to the due date.

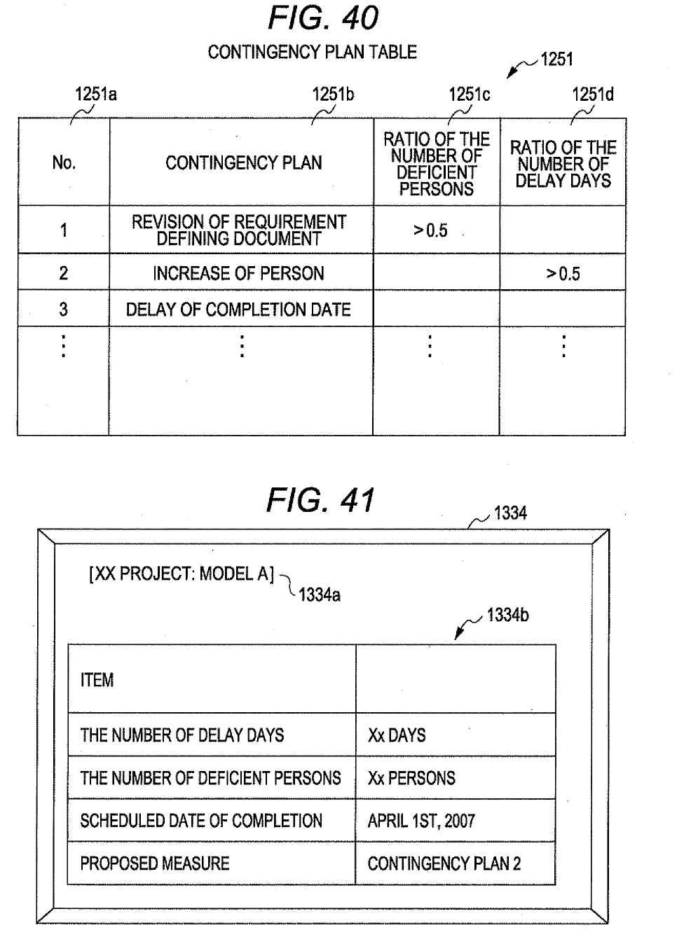

FIG. 40 illustrates an example of the contingency plan table.

A contingency plan 1251b is registered in a contingency plan table 1251 while related to a plan identifying number 1251a. A ratio of the number of deficient persons 1251c and a ratio of the number of delay days 1251d are also registered in the contingency plan table 1251 as conditions to which the contingency plan is applied to while related to the plan identifying number 1251a.

The contingency plan 1251b is a message which is displayed when the contingency plan is selected. The contingency plan is selected based on the current delay amount and the applied condition in the delay amount advice production processing 1 174, i.e., the ratio of the number of deficient persons 1251c and the ratio of the number of delay days 1251d in FIG. 40. For example, a “revision of requirement definition document” is selected when the ratio of the number of deficient persons is not lower than 0.5. An “increase of person” is selected when the ratio of the number of delay days is not lower than 0.5.

FIG. 41 illustrates an example of a delay amount advice display screen.

A project name 1334a and a table 1334b in which the current status and the measure for making up the delay amount are described are displayed on a delay amount advice display screen 1334. In FIG. 41, the measure of “increase of persons” of No. 2 in the contingency plan table 1251 is presented as the proposed plan.

The consensus status of the stakeholder on the requirement definition can easily be understood by performing the above-described processing procedure. The progress of the confirmation process can objectively be understood by the comparison with the model, and the number of delay days and the number of deficient persons can be predicted. Additionally, the delay of the process can be prevented because the proposed measure is also presented.

Thus, in the requirement confirmation support apparatus 100 of the embodiment, after the requirement confirmation process is performed, the generated information data can be left in the project result table and applied to the future work. Then, the requirement definition desirable practice management unit 1180 will be described.

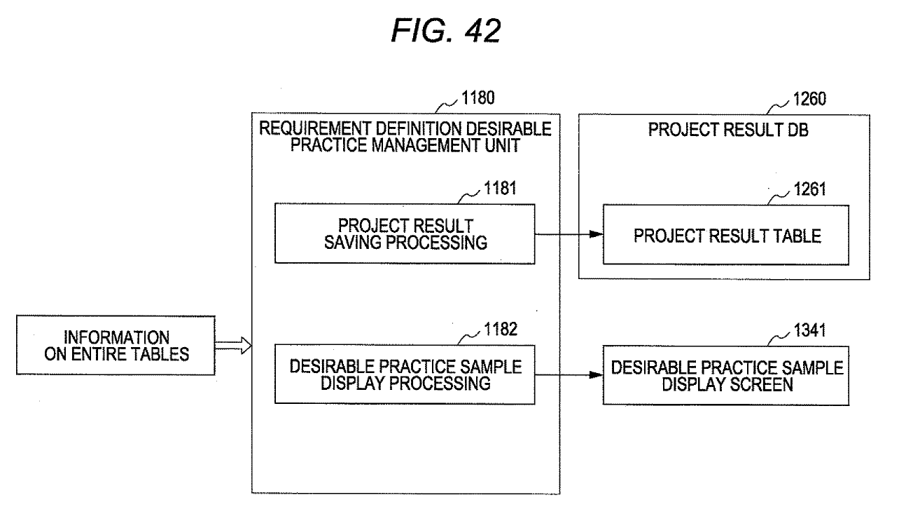

FIG. 42 illustrates a processing flow of the requirement definition desirable practice management unit of the embodiment.

The requirement definition desirable practice management unit 1180 performs project result saving processing 1181 for saving the result at the end of the project and desirable practice sample display processing 1182 for displaying a sample of the registered project result if needed.

In the project result saving processing 1181, the necessary information among the pieces of information of all the tables generated in the target project confirmation support processing is registered in the project result DB 1260 at the end of the project. The user provides a registration instruction when the project is ended. Whether the result is success or failure is registered at that time.

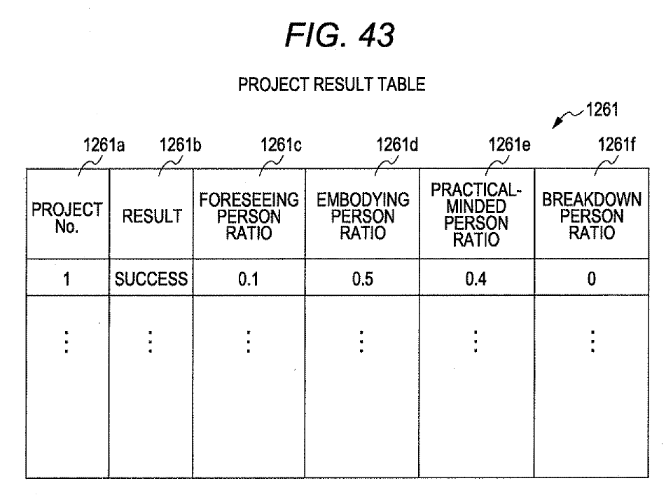

FIG. 43 illustrates an example of a project result table.

A success/failure result 1261b set by the user is registered in a project result table 1261 while related to a project number 1261a. A foreseeing person ratio 1261c, an embodying person ratio 1261d, a practical-minded person ratio 1261e, and a breakdown person ratio 1261f of the requirement defining model applied to the project are also registered in the project result table 1261 while related to the project number 1261a.

In the case of the project in which the requirement definition is newly performed, before the requirement definition, the pieces of result information (such as a project profile, a cluster ratio, requirement defining time, and the number of reviews) of the successful project are extracted by referring to the project result table 1261, and the pieces of result information are displayed on a desirable practice sample display screen 1341.

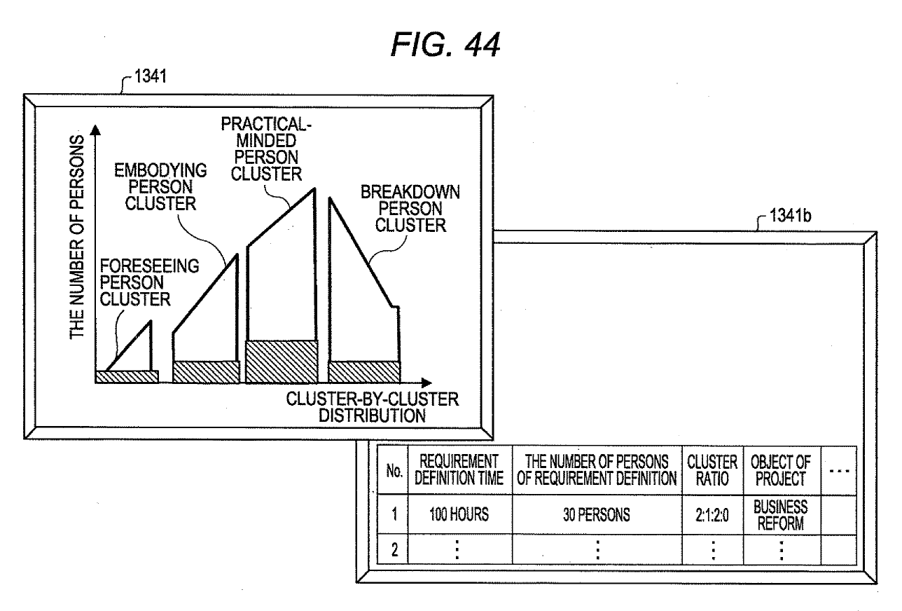

FIG. 44 illustrates an example of the desirable practice sample display screen.

The cluster distribution of the past project which is designated as the desirable practice and reference information 1341b which is of the information on the project are displayed on the desirable practice sample display screen 1341.

A successful desirable practice can be designated in the embodiment. Alternatively, desirable/undesirable practice may be displayed by referring to the failed project.

The desirable practice may be registered as the requirement defining model so as to be used in the next-time processing or later.

Thus, the confirmation support more suitable to the information system can be provided by storing the data.

The above-described processing can be performed by a computer. In such cases, a program is provided in which processing contents of the functions to be possessed by the requirement confirmation support apparatus are described. The computer executes the program, whereby the processing is realized on the computer. The program in which the processing contents are described can be recorded in a computer-readable recording medium. Examples of the computer-readable recording medium include a magnetic recording device, an optical disk, a magneto-optical recording medium, and a semiconductor memory. Examples of the magnetic recording device include a hard disk drive (HDD), a flexible disk (FD), and a magnetic tape. Examples of the optical disk include DVD (Digital Versatile Disc), DVD-RAM (Random Access Memory), CD-ROM (Compact Disc Read Only Memory), and CD-R (Recordable)/RW (Re Writable). MO (Magneto-Optical disk) can be cited as an example of the magneto-recording medium.

In the case where the program is distributed, for example, a portable recording medium such as DVD and CD-ROM in which the program is recorded can be s sold. The program can be stored in the storage device of the server computer and transferred from the server computer to another computer through the network.

In the computer executing the program, for example, the program recorded in the portable recording medium or the program transferred from the server computer is stored in the storage device. The computer reads the program from the storage device thereof and performs processing according to the program. Alternatively, the computer can directly read the program from the portable recording medium and perform the processing according to the program. Alternatively, the computer can perform the processing according to the program each time when the program is transferred from the server computer.

Although a few embodiments have been shown and described, it would be appreciated by those skilled in the art that changes may be made in these embodiments without departing from the principles and spirit of the invention, the scope of which can be defined in the claims and their equivalents.

What is claimed is:

1. A computer-readable recording medium having recorded therein a requirement confirmation support program which supports a requirement defining process in information system development, the requirement confirmation support program causing a computer to function as:
stakeholder determination means for classifying a stakeholder involved in a target project information system into a stakeholder type based on related information characterizing the stakeholder and including a history and a published document of the stakeholder, the stakeholder type being defined by a requirement defining model which is obtained by modeling a process until a requirement can be defined by the stakeholder involved in the information system is accepted since defined in an information system development process, the stakeholder determination means generating stakeholder information in which a cluster corresponding to the classified stakeholder type and stakeholder identification information for individually specifying the stakeholder are related to each other, and storing the stakeholder information in stakeholder information storage means;
cluster distribution generating means for computing the number of stakeholders belonging to the cluster and a number ratio in each cluster based on the stakeholder information, the cluster distribution generating means storing the number of stakeholders and the number ratio as cluster distribution information of the stakeholder in cluster distribution information storage means, and displaying a cluster distribution display screen based on the cluster distribution information if needed;
requirement defining model generating means for computing a cluster distribution model concerning the information system based on a distribution ratio of the stakeholder of each cluster defined by the requirement defining model, the requirement defining model generating means storing the cluster distribution model in requirement defining model information storage means, and displaying a requirement defining model display screen based on the cluster distribution model if needed;
satisfaction level measuring means for, when manipulation of a satisfaction button, which is manipulated when the stakeholder is satisfied with each item of the requirement definition, is inputted, generating item information which specifies an item of the manipulated requirement definition and a manipulation status including a manipulated date and time and the number of manipulations while the item information and the manipulation status are related to the stakeholder identification information, the satisfaction level measuring means storing the item information and the manipulation status in satisfaction information storage means; and
cluster-by-cluster satisfaction level generating means for aggregating a satisfaction level in each cluster based on the satisfaction information stored in the satisfaction information storage means and the stakeholder information stored in the stakeholder information storage means, the cluster-by-cluster satisfaction level generating means displaying a cluster-by-cluster satisfaction level display screen based on the aggregation information.

2. The recording medium according to claim 1, wherein the stakeholder determination means classifies, based on the requirement defining model, the stakeholder, which performs a requirement definition to the information system, into the stakeholder types including a foreseeing person who initially presents an innovative requirement, an embodying person who presents a vision-oriented requirement, a practical-minded person who presents a realistic requirement for a resource and technology, and a breakdown person who presents a conservative or skeptical requirement skeptical,
a foreseeing person cluster, an embodying person cluster, a practical-minded person cluster, and a breakdown person cluster are provided while corresponding to the foreseeing person, embodying person, practical-minded person, and breakdown person, and
the stakeholder involved in the target project information system is classified into one of the foreseeing person cluster, the embodying person cluster, the practical-minded person cluster, and the breakdown person cluster.

3. The recording medium according to claim 1, wherein the stakeholder determination means is caused to perform:
stakeholder registration processing for extracting related persons including an ordering person, a designer, an operator, and a user of the target project information system, and allocating and registering the stakeholder identification information as the stakeholder; and
cluster classification processing for searching the related information extracted for the stakeholder based on a determination keyword set in each previously-set cluster, and classifying the stakeholder into the cluster according to an emergency frequency of the determination keyword in the related information.

4. The recording medium according to claim 1, wherein the computer is further caused to function as requirement defining model selecting means for analyzing a feature of the target project based on related information on the target project, and selecting the requirement defining model suitable to the analyzed feature of the target project from among a plurality of requirement defining models which are previously prepared according to the feature of the target project, and
the requirement defining model generating means uses the requirement defining model selected by the requirement defining model selecting means.

5. The recording medium according to claim 4, wherein the requirement defining model selecting means previously stores in the requirement defining model information storage means a correspondence table in which a predetermined keyword is related to the requirement defining model suitable to the keyword, and collates the related information with the keyword in the corresponding table to select the requirement defining model having the most matched keywords.

6. The recording medium according to claim 5, wherein the requirement defining model selecting means sets the keyword in each element including a business sector, an object, and a scale of the project, selects an optimum requirement defining model candidate in each element, and then selects the requirement defining model suitable to the target project from the requirement defining model candidates.

7. The recording medium according to claim 1, wherein the computer is further caused to function as requirement definition delay measure means for comparing a cluster-by-cluster satisfaction level computed by the cluster-by-cluster satisfaction level generating means with a reference satisfaction level which is necessary in the cluster computed based on the requirement defining model, thereby to compute a delay status of the cluster-by-cluster satisfaction level.

8. The recording medium according to claim 7, wherein the requirement definition delay measure means compares the cluster satisfaction level and the reference satisfaction level in each cluster to display a display screen in which the cluster below the reference satisfaction level is clearly indicated.

9. The recording medium according to claim 7, wherein the requirement definition delay measure means previously stores a message of a measure against the delay status in delay measure storage means while related to the delay status, and when the delay status is detected, extracts the message of the measure against the delay status based on the delay status to display the extracted message of the delay measure on the display screen.

10. The recording medium according to claim 1, wherein the computer is further caused to function as requirement definition desirable practice management means for, when a user inputs project result information indicating success or failure at the end of the target project, storing in project result information storage means necessary setting information and the project result information while the necessary setting information and the project result information are related to project identification information specifying the project, the setting information including the stakeholder information involved in the target project, the cluster distribution information, the requirement defining model, and the satisfaction information, the requirement definition desirable practice management means extracting the setting information and the project result information from the project result information storage means in response to a reference request from the user, and displaying an sample based on the extracted pieces of information.

11. The recording medium according to claim 1, wherein, when a user sets any specified time, the cluster-by-cluster satisfaction level generating means collates the specified time based on a date and time when the manipulation set to the satisfaction information has been performed, and aggregates a satisfaction level in each cluster using the past satisfaction information closest to the specified time.

12. The recording medium according to claim 1, wherein, when a user sets any specified period and a specified interval, the cluster-by-cluster satisfaction level generating means collates the specified period based on a date and time when the manipulation set to the satisfaction information has been performed, samples the satisfaction information included in the specified period at specified intervals to aggregate the satisfaction level in each cluster, and then computes transition of the satisfaction level in each cluster.

13. A requirement confirmation support method for supporting requirement confirmation in a requirement defining process in information system development, the requirement confirmation support method comprising:
classifying a stakeholder involved in a target project information system into a stakeholder type based on related information characterizing the stakeholder and including a history and a published document of the stakeholder, the stakeholder type being defined by a requirement defining model which is obtained by modeling a process until a requirement can be defined by the stakeholder involved in the information system is accepted since defined in an information system development process, generating stakeholder information in which a cluster corresponding to the classified stakeholder type and stakeholder identification information for individually specifying the stakeholder are related to each other, and storing the stakeholder information;
computing the number of stakeholders belonging to the cluster and a number ratio in each cluster based on the stakeholder information, stores the number of stakeholders and the number ratio as cluster distribution information of the stakeholder in cluster distribution information storage, and displays a cluster distribution display screen based on the cluster distribution information if needed;
computing a cluster distribution model concerning the information system based on a distribution ratio of the stakeholder of each cluster defined by the requirement defining model, stores the cluster distribution model in requirement defining model information storage, and displays a requirement defining model display screen based on the cluster distribution model if needed;
generating, when manipulation of a satisfaction button, which is manipulated when the stakeholder is satisfied with each item of the requirement definition, is inputted, item information which specifies an item of the manipulated requirement definition and a manipulation status including a manipulated date and time and the number of manipulations while the item information and the manipulation status are related to the stakeholder identification information, and stores the item information and the manipulation status in satisfaction information storage; and
aggregating a satisfaction level in each cluster based on the satisfaction information stored and the stakeholder information stored, and displays a cluster-by-cluster satisfaction level display screen based on the aggregation information.

14. A requirement confirmation support apparatus for supporting requirement confirmation in a requirement defining process in information system development, the requirement confirmation support apparatus comprising:
a stakeholder information storage for storing stakeholder information on a stakeholder;
a cluster distribution information storage for storing distribution information on the stakeholder belonging to a cluster;
a requirement defining model storage for storing a cluster distribution model based on a requirement defining model corresponding to the information system;
a satisfaction information storage for storing satisfaction information in each stakeholder;
a stakeholder determiner for classifying a stakeholder involved in a target project information system into a stakeholder type based on related information characterizing the stakeholder and including a history and a published document of the stakeholder, the stakeholder type being defined by a requirement defining model which is obtained by modeling a process until a requirement can be defined by the stakeholder involved in the information system is accepted since defined in an information system development process, the stakeholder determiner generating stakeholder information in which a cluster corresponding to the classified stakeholder type and stakeholder identification information for individually specifying the stakeholder are related to each other, and storing the stakeholder information in the stakeholder information storage;
a cluster distribution generator for computing the number of stakeholders belonging to the cluster and a number ratio in each cluster based on the stakeholder information, the cluster distribution generator storing the number of stakeholders and the number ratio as the cluster distribution information of the stakeholder in cluster distribution information storage, and displaying a cluster distribution display screen based on the cluster distribution information if needed;
a requirement defining model generator for computing the cluster distribution model concerning the information system based on a distribution ratio of the stakeholder of each cluster defined by the requirement defining model, the requirement defining model generating storing the cluster distribution model in the requirement defining model information storage, and displaying a requirement defining model display screen based on the cluster distribution model if needed;
a satisfaction level measurer for, when manipulation of a satisfaction button, which is manipulated when the stakeholder is satisfied with each item of the requirement definition, is inputted, generating item information which specifies an item of the manipulated requirement definition and a manipulation status including a manipulated date and time and the number of manipulations while the item information and the manipulation status are related to the stakeholder identification information, the satisfaction level measurer storing the item information and the manipulation status in the satisfaction information storage; and
a cluster-by-cluster satisfaction level generator for aggregating a satisfaction level in each cluster based on the satisfaction information stored in the satisfaction information storage and the stakeholder information stored in the stakeholder information storage, the cluster-by-cluster satisfaction level generator displaying a cluster-by-cluster satisfaction level display screen based on the aggregation information.
